(19) United States
(12) Patent Application Publication
(10) Pub. No.: US 2010/0210462 A1
(43) Pub. Date: Aug. 19, 2010

(54) HERBICIDAL COMPOSITION

(76) Inventor: Seiji Yamato, Nishinomiya-shi (JP)

Correspondence Address: BIRCH STEWART KOLASCH & BIRCH, PO BOX 747, FALLS CHURCH, VA, 22040-0747, US

(21) Appl. No.: 12/678,082

(22) PCT Filed: Sep. 12, 2008
(86) PCT No.: PCT/JP2008/066914

§ 371 Date: Mar. 12, 2010

(30) Foreign Application Priority Data
Sep. 14, 2007 (JP) 2007-239160

(51) Int. Cl. A01N 57/24; A01N 43/58; A01P 13/00

(52) U.S. Cl. 504/128; 504/137

(57) ABSTRACT

A herbicidal composition having an excellent weed control effect, which comprises a pyridazinone compound represented by the formula (I): wherein R¹ represents a C₁₋₆ alkyl group or a (C₁₋₆ alkyloxy)C₁₋₆ alkyl group, R² represents a hydrogen atom or a C₁₋₆ alkyl group; G represents a hydrogen atom, etc., Z¹ represents a C₁₋₆ alkyl group, Z² represents a C₁₋₆ alkyl group, n represents 0, 1, 2, 3 or 4, and when n represents an integer of two or more, each Z² may be the same or different, provided that the total number of carbon atoms in the groups represented by Z¹ and n×Z² is two or more; glyphosate or an agriculturally acceptable salt thereof; and a specific herbicide.

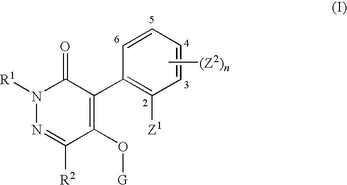

### TECHNICAL FIELD

The present invention relates to a herbicidal composition.

### BACKGROUND ART

Nowadays, a number of herbicides are commercially available (for example see non-Patent Document 1). However, in view of herbicidal effects and crop safety, there is a need for further diverse herbicidal compositions.

non-Patent Document 1: The Pesticide Manual, Thirteenth Edition (2003), British Crop Protection Council (ISBN: 1-901396-13-4)

### DISCLOSURE OF THE INVENTION

An object of the present invention is to provide a herbicidal composition having an excellent weed control.

The present inventors have studied intensively and found that a herbicidal composition comprising a pyridazinone compound represented by the general formula (I), glyphosate or an agriculturally acceptable salt thereof, and a specific herbicide exerts an excellent weed control in foliar or soil treatment against weeds. Thus, the present invention has been completed.

That is, the present invention provides:

[1] A herbicidal composition comprising a pyridazinone compound represented by the general formula (I):

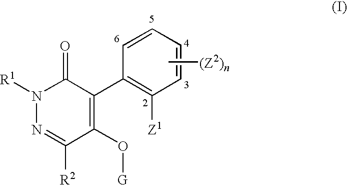

wherein R¹ represents a C₁₋₆ alkyl group or a (C₁₋₆ alkyloxy) C₁₋₆ alkyl group,
R² represents a hydrogen atom or a C₁₋₆ alkyl group,
G represents a hydrogen atom or any one of the groups represented by the following formulas:

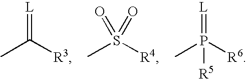

wherein L represents an oxygen atom or a sulfur atom,
R³ represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl) C₁₋₆ alkyl group, a C₁₋₆ alkyloxy group, a C₃₋₈ cycloalkyloxy group, a C₂₋₆ alkenyloxy group, a C₂₋₆ alkynyloxy group, a C₆₋₁₀ aryloxy group, a (C₆₋₁₀ aryl) C₁₋₆ alkyloxy group, an amino group, a C₁₋₆ alkylamino group, a C₂₋₆ alkenylamino group, a C₆₋₁₀ arylamino group, a di(C₁₋₆ alkyl)amino group, a di(C₂₋₆ alkenyl)amino group, a (C₁₋₆ alkyl) (C₆₋₁₀ aryl)amino group or a 3- to 8-membered nitrogen-containing heterocyclic group,
R⁴ represents a C₁₋₆ alkyl group, a C₆₋₁₀ aryl group, a C₁₋₆ alkylamino group or a di(C₁₋₆ alkyl)amino group, and

R⁵ and R⁶ are the same or different and each represents a C₁₋₆ alkyl group, a C₃₋₈ cycloalkyl group, a C₂₋₆ alkenyl group, a C₆₋₁₀ aryl group, a C₁₋₆ alkyloxy group, a C₃₋₈ cycloalkyloxy group, a C₆₋₁₀ aryloxy group, a (C₆₋₁₀ aryl) C₁₋₆ alkyloxy group, a C₁₋₆ alkylthio group, a C₁₋₆ alkylamino group or a di(C₁₋₆ alkyl)amino group,

provided that any group represented by R³, R⁴, R⁵ and R⁶ may be substituted with at least one halogen atom, and the C₃₋₈ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl) C₁₋₆ alkyloxy group, the aryl moiety of the C₆₋₁₀ arylamino group, the aryl moiety of the (C₁₋₆ alkyl)(C₆₋₁₀ arylamino group and the 3- to 8-membered nitrogen-containing heterocyclic group may be substituted with at least one C₁₋₆ alkyl group,
Z¹ represents a C₁₋₆ alkyl group; Z² represents a C₁₋₆ alkyl group,
n represents 0, 1, 2, 3 or 4, and when n represents an integer of two or more, each Z² may be the same or different, provided that the total number of carbon atoms in the groups represented by Z¹ and n×Z² is two or more; glyphosate or an agriculturally acceptable salt thereof; and a herbicidal compound selected from the following group A.

### Group A:

metolachloror an optically active isomer thereof,
acetochlor,
atrazine,
dicamba, and
2,4-D or an agriculturally acceptable salt or ester thereof

[2] The herbicidal composition according to the above [1], wherein n in the general formula (I) is an integer of 1 or more.

[3] The herbicidal composition according to the above [1], wherein n in the general formula (I) is 0, and Z¹ is a C₂₋₆ alkyl group.

[4] The herbicidal composition according to the above [1], wherein n in the general formula (I) is 1 or 2, and Z² is attached to the benzene ring at 4- and/or 6-positions thereof.

[5] The herbicidal composition according to the above [1], [2] or [4], wherein Z¹ in the general formula (I) is a C₁₋₃ alkyl group, and Z² is a C₁₋₃ alkyl group.

[6] The herbicidal composition according to any one of the above [1] to [5], wherein G in the general formula (I) is a hydrogen atom or any one of the groups represented by the following formulas:

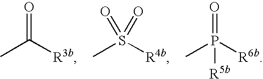

wherein R^{3b} represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl) C₁₋₆ alkyl group, a C₁₋₆ alkyloxy group, a C₃₋₈ cycloalkyloxy group, a C₆₋₁₀ aryloxy group, a (C₆₋₁₀ aryl) C₁₋₆ alkyloxy group, a C₁₋₆ alkylamino group, a (C₆₋₁₀ arylamino group or a di(C₁₋₆ alkyl)amino group,
R^{4b} represents a C₁₋₆ alkyl group or a C₆₋₁₀ aryl group, and
R^{5b} and R^{6b} are the same or different and each represents a C₁₋₆ alkyl group, a C₁₋₆ alkyloxy group, a C₆₋₁₀ aryloxy group or a C₁₋₆ alkylthio group,

provided that any group represented by R^{3b}, R^{4b}, R^{5b} and R^{6b} may be substituted with at least one halogen atom, and the C₃₋₈ cycloalkyl group, the C₆₋₁₀ aryl group, the aryl moiety of the (C₆₋₁₀ aryl) C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group and the aryl moiety of the C₆₋₁₀ arylamino group may be substituted with at least one C₁₋₆ alkyl group.

[7] The herbicidal composition according to any one of the above [1] to [5], wherein G in the general formula (I) is a hydrogen atom or any one of the groups represented by the following formulas:

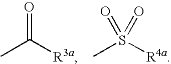

wherein R^{3a} represents a C₁₋₆ alkyl group, a C₃₋₈ cycloalkyl group, a C₆₋₁₀ aryl group, a C₁₋₆ alkyloxy group or a di(C₁₋₆ alkylamino group; and
R^{4a} represents a C₁₋₆ alkyl group,
provided that any group represented by R^{3a} and R^{4a} may be substituted with a halogen atom, and a C₃₋₈ cycloalkyl group and a C₆₋₁₀ aryl group may be substituted with a C₁₋₆ alkyl group.

[8] The herbicidal composition according to any one of the above [1] to [7], wherein R² in the general formula (I) is a hydrogen atom or a C₁₋₃ alkyl group.

[9] The herbicidal composition according to any one of the above [1] to [7], wherein R² in the general formula (I) is a hydrogen atom or a methyl group.

[10] The herbicidal composition according to any one of the above [1] to [9], wherein R¹ in the general formula (I) is a C₁₋₃ alkyl group or a (C₁₋₃ alkyloxy) C₁₋₃ alkyl group.

[11] A weed control method, which comprises simultaneously or separately applying an effective amount of the pyridazinone compound according to any one of the above [1] to [10], an effective amount of glyphosate or an agriculturally acceptable salt thereof, and a herbicidal compound selected from the following group A.

### Group A:

metolachloror an optically active isomer thereof,
acetochlor,
atrazine,
dicamba, and
2,4-D or an agriculturally acceptable salt or ester thereof

[12] Use of the pyridazinone compound according to any one of the above [1] to [10], glyphosate or an agriculturally acceptable salt thereof, and a herbicidal compound selected from the following group A, for weed control.

### Group A:

metolachloror an optically active isomer thereof,
acetochlor,
atrazine,
dicamba, and
2,4-D or an agriculturally acceptable salt or ester thereof.

According to the present invention, it is made possible to provide an herbicidal composition having an excellent weed control.

### BEST MODE FOR CARRYING OUT THE INVENTION

Specifically, the herbicidal composition of the present invention includes:

a herbicidal composition containing the pyridazinone compound represented by the general formula (I), glyphosate or an agriculturally acceptable salt thereof and
metolachloror an optically active isomer thereof,
a herbicidal composition containing the pyridazinone compound represented by the general formula (I), glyphosate or an agriculturally acceptable salt thereof and acetochlor, a herbicidal composition containing the pyridazinone compound represented by the general formula (I), glyphosate or an agriculturally acceptable salt thereof and atrazine, a herbicidal composition containing the pyridazinone compound represented by the general formula (I), glyphosate or an agriculturally acceptable salt thereof and dicamba, and
a herbicidal composition containing the pyridazinone compound represented by the general formula (I), glyphosate or an agriculturally acceptable salt thereof and 2,4-D or an agriculturally acceptable salt or ester thereof.

In the substituents represented by R¹, R², R³, R⁴, R⁵, R⁶, Z¹ and Z² in the compound represented by the general formula (I) to be used as the active ingredient of the herbicidal composition of the present invention, the C₁₋₆ alkyl group means an alkyl group having 1 to 6 carbon atoms and examples thereof include a methyl group, an ethyl group, a propyl group, an isopropyl group, a butyl group, an isobutyl group, a sec-butyl group, a tert-butyl group, a pentyl group, a sec-pentyl group, an isopentyl group, a neopentyl group, a hexyl group and an isohexyl group;

the C₃₋₈ cycloalkyl group means a cycloalkyl group having 3 to 8 carbon atoms and examples thereof include a cyclopropyl group, a cyclopentyl group and a cyclohexyl group;
the C₂₋₆ alkenyl group means an alkenyl group having 2 to 6 carbon atoms and examples thereof include an allyl group, a 1-buten-3-yl group and a 3-buten-1-yl group;
the C₂₋₆ alkynyl group means an alkynyl group having 2 to 6 carbon atoms and examples thereof include a propargyl group and a 2-butynyl group;
the C₆₋₁₀ aryl group means an aryl group having 6 to 10 carbon atoms and examples thereof include a phenyl group and a naphthyl group;
the (C₆₋₁₀ aryl) C₁₋₆ alkyl group means a C₁₋₆ alkyl group substituted with a C₆₋₁₀ aryl group and examples thereof include a benzyl group and a phenethyl group;
the C₁₋₆ alkyloxy group means an alkyloxy group having 1 to 6 carbon atoms and examples thereof include a methoxy group, an ethoxy group, a propoxy group and an isopropoxy group;
the C₃₋₈ cycloalkyloxy group means a cycloalkyloxy group having 3 to 8 carbon atoms, e.g., a cyclopropyloxy and a cyclopentyloxy group;
the C₂₋₆ alkenyloxy group means an alkenyloxy group having 2 to 6 carbon atoms and examples thereof include a vinyloxy group and an allyloxy group;
the C₂₋₆ alkynyloxy group means an alkynyloxy group having 2 to 6 carbon atoms and examples thereof include a propargyloxy group and a 2-butynyloxy group;
the C₆₋₁₀ aryloxy group means an aryloxy group having 6 to 10 carbon atoms and examples thereof include a phenoxy group and a naphthoxy group;
the (C₆₋₁₀ aryl) C₁₋₆ alkyloxy group means a C₁₋₆ alkyloxy aryl group and examples thereof include a benzyloxy group and a phenethyloxy group;
the C₁₋₆ alkylamino group means an alkylamino group having 1 to 6 carbon atoms and examples thereof include a methylamino group and an ethylamino group;
the C₂₋₆ alkenylamino group means an alkenylamino group having 2 to 6 carbon atoms and examples thereof include an allylamine group and a 3-butenylamino group;
the C₆₋₁₀ arylamino group means an arylamino group having 6 to 10 carbon atoms and examples thereof include a phenylamino group and a naphthylamino group;
the di(C₁₋₆ alkylamino group means an amino group substituted with two the same or different C₁₋₆ alkyl groups and examples thereof include a dimethylamino group, a diethylamino group and an N-ethyl-N-methylamino group; the di(C₂₋₆ alkenyl)amino group means an amino group substituted with two the same or different C₂₋₆ alkenyl groups and examples thereof include a diallylamino group and a di(3-butenyl)amino group;
the (C₁₋₆ alkyl) (C₆₋₁₀ aryl)amino group means an amino group substituted with a C₂₋₆ alkyl group and a C₆₋₁₀ aryl group and examples thereof include a methylphenylamino group and an ethylphenylamino group;
the C₁₋₆ alkylthio group means an alkylthio group having 1 to 6 carbon atoms and examples thereof include a methylthio group, an ethylthio group, a propylthio group and an isopropylthio group;
the (C₁₋₆ alkyloxy) C₁₋₆ alkyl group means a C₁₋₆ alkyl group substituted with a C₁₋₆ alkyloxy group and examples thereof include a methoxyethyl group and an ethoxyethyl group; and
the 3- to 8-membered nitrogen-containing heterocyclic group means an aromatic or alicyclic 3- to 8-membered heterocyclic group, which contains 1 to 3 nitrogen atoms, and may contain 1 to 3 oxygen atoms and/or sulfur atoms and examples thereof include a 1-pyrazolyl group, a 2-pyridyl group, a 2-pyrimidinyl group, a 2-thiazolyl group, a pyrrolidino group, a piperidino group and a morpholino group.

Examples of the halogen atom, with which a group represented by R³, R⁴R⁵ and R⁶ may be substituted, include a fluorine atom, a chlorine atom, a bromine atom and an iodine atom.

Examples of the C₁₋₈ alkyl group, with which the C₃₋₈ cycloalkyl group, the C₆₋₁₀ aryl group, the aryl moiety of the (C₆₋₁₀ aryl) C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group, the aryl moiety of the C₆₋₁₀ arylamino group, the aryl moiety of the (C₁₋₆ alkyl) (C₆₋₁₀ aryl)amino group and the 3- to 8-membered nitrogen-containing heterocyclic group in the group represented by R³, R⁴, R⁵ and R⁶ may be substituted, include a methyl group, an ethyl group, a propyl group, a butyl group and the like.

Among the compounds represented by the general formula (I) to be used as the active ingredient of the herbicidal composition of the present invention, a compound represented by the general formula (I-a), i.e., the present compound wherein G is a hydrogen atom, may have tautomers represented by the general formulas (I-a′) and (I-a″). The compound represented by the general formula (I-a) includes all of the tautomers and a mixture of any two or more of them.

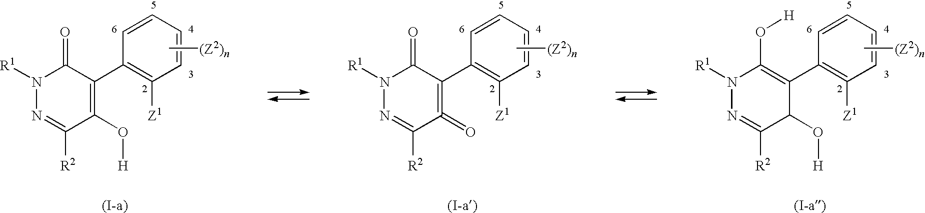

Agriculturally acceptable salts of the compound represented by the general formula (I-a) to be used as the active ingredient of the herbicidal composition of the present invention include those formed by the compound represented by the general formula (I-a) and inorganic bases such as hydroxides, carbonates, hydrogen carbonates, acetates and hydrides of alkali metals (e.g., lithium, sodium and potassium), hydroxides and hydrides of alkaline earth metals (e.g., magnesium, calcium and barium), and ammonia; organic bases such as dimethylamine, triethylamine, piperazine, pyrrolidine, piperidine, 2-phenylethylamine, benzylamine, ethanolamine, diethanolamine, pyridine and collidine; metal alkoxides such as sodium methoxide, potassium tert-butoxide and magnesium methoxide; and the like.

When the present compound has one or more asymmetric centers, there exist two or more stereoisomers (e.g., enantiomers and diastereomers) in the compound. The compound represented by the general formula (I) includes all of the stereoisomers and a mixture of any two or more of them.

When the present compound has geometric isomerism based on a double bond, there exist two or more geometric isomers (e.g., E/Z or trans/cis isomers, and S-trans/S-cis isomers) in the compound. The present compound includes all of the geometric isomers and a mixture of two or more of them.

Preferred embodiments of the present compound used as the active ingredient for the herbicidal composition of the present invention are as follows.

The pyridazinone compound represented by the general formula (I), wherein n is an integer of 1 or more.

The pyridazinone compound represented by the general formula (I), wherein n is 0, and Z¹ is a C₂₋₆ alkyl group.

The pyridazinone compound represented by the general formula (I), wherein n is 1 or 2, and Z² is attached to the benzene ring at 4- and/or 6-positions thereof.

The pyridazinone compound represented by the general formula (I), wherein G represents a hydrogen atom or any one of the groups represented by the following formulas:

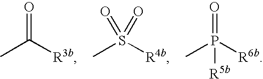

wherein R^{3b} represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl) C₁₋₆ alkyl group, a C₁₋₆ alkyloxy group, a C₃₋₈ cycloalkyloxy group, a C₆₋₁₀ aryloxy group, a (C₆₋₁₀ aryl) C₁₋₆ alkyloxy group, a C₁₋₆ alkylamino group, a C₆₋₁₀ arylamino group or a di(C₁₋₆ alkyl)amino group;
R^{4b} represents a C₁₋₆ alkyl group or a C₆₋₁₀ aryl group; and
R^{5b} and R^{6b} are the same or different and each represents a C₁₋₆ alkyl group, a C₁₋₆ alkyloxy group, a C₆₋₁₀ aryloxy group or a C₁₋₆ alkylthio group,
provided that any group represented by R^{3b}, R^{4b}, R^{5b} and R^{6b} may be substituted with at least one halogen atom, and the C₃₋₈ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group and the aryl moiety of the C₆₋₁₀ arylamino group may be substituted with at least one C₁₋₆ alkyl group.

The pyridazinone compound represented by the general formula (I), wherein G represents a hydrogen atom or any one of the groups represented by the following formulas:

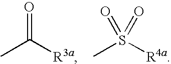

wherein R^{3a} represents a C₁₋₆ alkyl group, a C₃₋₈ cycloalkyl group, a C₆₋₁₀ aryl group, a C₁₋₆ alkyloxy group or a di(C₁₋₆ alkyl)amino group;
R^{4a} represents a C₁₋₆ alkyl group,
provided that any group represented by R^{3a} and R^{4a} may be substituted with a halogen atom, and a C₃₋₈ cycloalkyl group and a C₆₋₁₀ aryloxy group may be substituted with a C₁₋₆ alkyl group.

The pyridazinone compound represented by the general formula (I), wherein R¹ represents a C₁₋₃ alkyl group or a (C₁₋₃ alkyloxy) C₁₋₃ alkyl group.

The pyridazinone compound represented by the general formula (I), wherein R² represents a C₁₋₃ alkyl group.

The pyridazinone compound represented by the general formula (I), wherein R² represents a hydrogen atom or a methyl group.

The pyridazinone compound represented by the general formula (I), wherein Z¹ represents a C₁₋₃ alkyl group, and Z² represents a C₁₋₃ alkyl group.

The pyridazinone compound represented by the general formula (I), wherein R¹ represents a C₁₋₃ alkyl group or a (C₁₋₃ alkyloxy) C₁₋₃ alkyl group, and R² represents a hydrogen atom or a C₁₋₃ alkyl group.

The pyridazinone compound represented by the general formula (I), wherein R¹ represents a C₁₋₃ alkyl group or a (C₁₋₃ alkyloxy) C₁₋₃ alkyl group, and R² represents a hydrogen atom or a methyl group.

The pyridazinone compound represented by the general formula (I), wherein R² represents a hydrogen atom or a C₁₋₃ alkyl group, and G represents a hydrogen atom or any one of the groups represented by the following formulas:

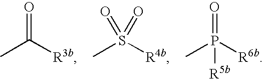

wherein R^{3b}, R^{4b}, R^{5b} and R^{6b} are as defined above.

The pyridazinone compound represented by the general formula (I), wherein R² represents a hydrogen atom or C₁₋₃ alkyl group, and G represents a hydrogen atom or any one of the groups represented by the following formulas:

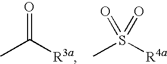

wherein R^{3a} and R^{4a} are as defined above.

The pyridazinone compound represented by the general formula (I), wherein R² represents a hydrogen atom or a methyl group, and G represents a hydrogen atom or any one of the groups represented by the following formulas:

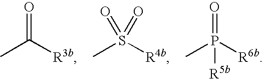

wherein R^{3b}, R^{4b}, R^{5b} and R^{6b} are as defined above.

The pyridazinone compound represented by the general formula (I), wherein R² represents a hydrogen atom or methyl group, and G represents a hydrogen atom or any one of the groups represented by the following formula.

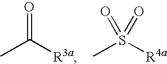

wherein R^{3a} and R^{4a} are as defined above.

The pyridazinone compound represented by the general formula (I), wherein R¹ represents a C₁₋₃ alkyl group or a (C₁₋₃ alkyloxy)C₁₋₃ alkyl group, R² represents a hydrogen atom or a C₁₋₃ alkyl group, and G represents a hydrogen atom or any one of the groups represented by the following formulas:

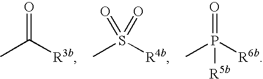

wherein R^{3b}, R^{4b}, R^{5b} and R^{6b} are as defined above.

The pyridazinone compound represented by the general formula (I), wherein R¹ represents a C₁₋₃ alkyl group or a (C₁₋₃ alkyloxy)C₁₋₃ alkyl group, R² represents a hydrogen atom or a C₁₋₃ alkyl group, and G represents a hydrogen atom or any one of the groups represented by the following formulas:

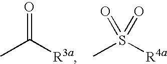

wherein R^{3a} and R^{4a} are as defined above.

The pyridazinone compound represented by the general formula (I), wherein R¹ represents a C₁₋₃ alkyl group or a (C₁₋₃ alkyloxy)C₁₋₃ alkyl group, R² represents a hydrogen atom or a methyl group, and G represents a hydrogen atom or any one of the groups represented by the following formulas:

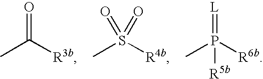

wherein R^{3b}, R^{4b}, R^{5b} and R^{6b} are as defined above.

The pyridazinone compound represented by the general formula (I), wherein R¹ represents a C₁₋₃ alkyl group or a (C₁₋₃ alkyloxy)C₁₋₃ alkyl group, R² represents a hydrogen atom or a methyl group, and G represents a hydrogen atom or any one of the groups represented by the following formulas:

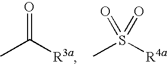

wherein R^{3a} and R^{4a} are as defined above.

The pyridazinone compound represented by the general formula (I), wherein R¹ represents a C₁₋₃ alkyl group or a (C₁₋₃ alkyloxy)C₁₋₃ alkyl group, R² represents a hydrogen atom or a C₁₋₃ alkyl group,

n is an integer of 0, 1 or 2 and, when n is 2, two Z² may be the same or different, while when n is 1 or 2, Z² is attached to the benzene ring at 4- and/or 6-positions thereof,
Z¹ represents a C₁₋₆ alkyl group (more preferably a C₁₋₃ alkyl group), and
Z² represents a C₁₋₆ alkyl group (more preferably a C₁₋₃ alkyl group).

The pyridazinone compound represented by the general formula (I), wherein R¹ represents a C₁₋₃ alkyl group or a (C₁₋₃ alkyloxy)C₁₋₃ alkyl group, R² represents a hydrogen atom or a C₁₋₃ alkyl group, G represents a hydrogen atom or any one of the groups represented by the following formulas:

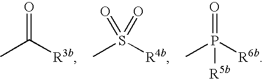

wherein R^{3b}, R^{4b}, R^{5b} and R^{6b} are as defined above,
n is an integer of 0, 1 or 2 and, when n is 2, two Z² may be the same or different, while when n is 1 or 2, Z² is attached to the benzene ring at 4- and/or 6-positions thereof,
Z¹ represents a C₁₋₆ alkyl group (more preferably a C₁₋₃ alkyl group, and
Z² represents a C₁₋₆ alkyl group (more preferably a C₁₋₃ alkyl group).

The pyridazinone compound represented by the general formula (I), wherein R¹ represents a C₁₋₃ alkyl group or a (C₁₋₃ alkyloxy)C₁₋₃ alkyl group, R² represents a hydrogen atom or a C₁₋₃ alkyl group, G represents a hydrogen atom or any one of the groups represented by the following formulas:

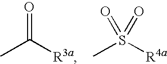

wherein R^{3a} and R^{4a} are as defined above,
n is an integer of 0, 1 or 2 and, when n is 2, two Z² may be the same or different, while when n is 1 or 2, Z² is attached to the benzene ring at 4- and/or 6-positions thereof,
Z¹ represents a C₁₋₆ alkyl group (more preferably a C₁₋₃ alkyl group, and
Z² represents a C₁₋₆ alkyl group (more preferably a C₁₋₃ alkyl group).

The pyridazinone compound represented by the general formula (I), wherein R¹ represents a C₁₋₃ alkyl group or a alkyloxy)C₁₋₃ alkyl group, R² represents a hydrogen atom or a methyl group,

n is an integer of 0, 1 or 2 and, when n is 2, two Z² may be the same or different, while when n is 1 or 2, Z² is attached to the benzene ring at 4- and/or 6-positions thereof,
Z¹ represents a C₁₋₆ alkyl group (more preferably a C₁₋₃ alkyl group), and
Z² represents a C₁₋₆ alkyl group (more preferably a C₁₋₃ alkyl group).

The pyridazinone compound represented by the general formula (I), wherein R¹ represents a C₁₋₃ alkyl group or a (C₁₋₃ alkyloxy) C₁₋₃ alkyl group, R² represents a hydrogen atom or a methyl group, G represents a hydrogen atom or any one of the groups represented by the following formulas:

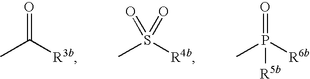

wherein R^{3b}, R^{4b}, R^{5b} and R^{6b} are as defined above,
n represents an integer of 0, 1 or 2 and, when n is 2, two Z² may be the same or different, while when n is 1 or 2, Z² is attached to the benzene ring at 4- and/or 6-positions thereof,
Z¹ represents a C₁₋₆ alkyl group (more preferably a C₁₋₃ alkyl group), and
Z² represents a C₁₋₆ alkyl group (more preferably a C₁₋₃ alkyl group).

The pyridazinone compound represented by the general formula (I), wherein R¹ represents a C₁₋₃ alkyl group or a (C₁₋₃ alkyloxy)C₁₋₃ alkyl group, R² represents a hydrogen atom or methyl group, G represents a hydrogen atom or any one of the groups represented by the following formulas:

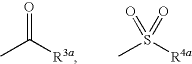

wherein R^{3a} and R^{4a} are as defined above,
n is an integer of 0, 1 or 2 and, when n is 2, two Z² may be the same or different, while when n is 1 or 2, Z² is attached to the benzene ring at 4- and/or 6-positions thereof,
Z¹ represents a C₁₋₆ alkyl group (more preferably a C₁₋₃ alkyl group), and
Z² represents a C₁₋₆ alkyl group (more preferably a C₁₋₃ alkyl group).

The pyridazinone compound represented by the general formula (I-1),

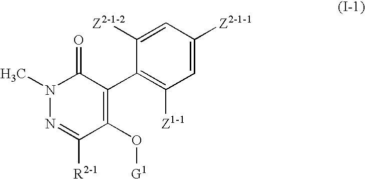

wherein R²⁻¹ represents a hydrogen atom or a C₁₋₃ alkyl group,
G¹ represents a hydrogen atom, or a C₁₋₃ alkylcarbonyl, C₁₋₃ alkoxycarbonyl or C₆₋₁₀ arylcarbonyl group which may be substituted with a halogen atom,
Z¹⁻¹ represents a C₁₋₃ alkyl group,
Z²⁻¹⁻¹ represents a C₁₋₃ alkyl group, and
Z²⁻¹⁻² represents a hydrogen atom or a C₁₋₃ alkyl group.

The pyridazinone compound represented by the general formula (I-1), wherein R²⁻¹ represents a hydrogen atom, a methyl group or an ethyl group, G¹ represents a hydrogen atom, an acetyl group, a propionyl group, a methoxycarbonyl group, an ethoxycarbonyl group or a benzoyl group,

Z¹⁻¹ represents a methyl group or an ethyl group,
Z²⁻¹⁻¹ represents a methyl group or an ethyl group, and
Z²⁻¹⁻² represents a hydrogen atom, a methyl group or an ethyl group.

The pyridazinone compound represented by the general formula (I-2),

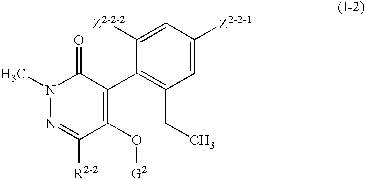

wherein R²⁻² represents a hydrogen atom or a C₁₋₃ alkyl group,
G² represents a hydrogen atom, or a C₁₋₃ alkylcarbonyl or C₁₋₃ alkoxycarbonyl group which may be substituted with a halogen atom,
Z²⁻²⁻¹ represents a hydrogen atom or a C₁₋₃ alkyl group, and
Z²⁻²⁻² represents a hydrogen atom or a C₁₋₃ alkyl group.

The pyridazinone compound represented by the general formula (I-2), wherein R²⁻² represents a hydrogen atom, a methyl group or an ethyl group, G² represents a hydrogen atom, an acetyl group, a methoxycarbonyl group or an ethoxycatbonyl group,

Z²⁻²⁻¹ represents a hydrogen atom, a methyl group or an ethyl group, and
Z²⁻²⁻² represents a hydrogen atom, a methyl group or an ethyl group.

Glyphosate or an agriculturally acceptable salt thereof is a known compound and is commercially available. It is prepared by a method described in U.S. Pat. No. 3,799,758, etc.

Metolachloror an optically active isomer thereof is a known compound and is commercially available. It is prepared by a method described in JP 49-54527 A, U.S. Pat. No. 5,002,606, etc.

Acetochlor is a known compound and is commercially available. It is prepared by a method described in German Patent No. 2,365,451, etc.

Atrazine is a known compound and is commercially available. It is prepared by a method described in U.S. Pat. Nos. 2,891,8554 and 3,152,881, etc.

Dicamba is a known compound and is commercially available. It is prepared by a method described in U.S. Pat. No. 3,013,054, etc.

2,4-D or an agriculturally acceptable salt or ester thereof is a known compound and is commercially available. It is prepared by a method described in Journal of the American Chemical Society (1941), Vol. 63, p 1768, etc.

The herbicidal composition of the present invention has a herbicidal activity to a wide range of weeds, and can effectively control various weeds in fields for crops, vegetables and trees or in non-crop lands, where conventional tillage or non-tillage cultivation is carried out.

Examples of weeds that the present inventive herbicidal composition can control are as follows. Weeds growing in fields such as Digitaria adscendens, Eleusine indica, Setaria viridis, Setaria faberi, Setaria glauca, Echinochloa crus-galli, Panicum dichotomiflorum, Panicum texanum, Brachiaria platyphylla, Sorghum halepense, Sorghum bicolor, Cynodone dactylon, Avena fatua, Lolium multiflorum, Alopecurus myosuroides, Bromus tectorum, Bromus sterilis, Phalaris minor, Apera spica-venti, Poa annua, Agropyron repens, Cyperus iria, Cyperus rotundus, Cyperus esculentus, Portulaca oleracea, Amaranthus retroflexus, Amaranthus hybridus, Abutilon theophrasti, Sida spinosa, Polygonum convolvulus, Polygonum lapathifolium, Polygonum pensylvanicum, Polygonum persicaria, Rumex crispus, Rumex obtusifolius, Polygonum cuspidatum, Chenopodium album, Kochia scoparia, Polygonum longisetum, Solanum nigrum, Datura stramonium, Ipomoea purpurea, Ipomoea hederacea, Ipomoea hederacea var. integriuscula, Ipomoea lacunosa, Convolvulus arvensis, Lamium purpureum, Lamium amplexicaule, Xanthium strumarium, Helianthus spp., Matricaria inodora, Matricaria chamomilla, Chrysanthemum segetum, Maticaria matricarioides, Ambrosia artemisiifolia, Ambrosia trifida, Erigeron canadensis, Artemisia vulgaris, Solidago altissima, Sesbania exaltata, Cassia obtusifolia, Desmodium tortuosum, Trifolium repens, Pueraria Iobata, Vicia sativa, Commelina communis, Commelina benghalensis, Galium aparine, Stellaria media, Raphanus raphanistrum, Sinapis arvensis, Capsella bursa-pastoris, Veronica persica, Veronica hederifolia, Viola arvensis, Viola tricolor, Papaver rhoeas, Myosotis arvensis, Asclepias syriaca, Euphorbia helioscopia, Euphorbia maculata, Geranium carolinianum, Erodium cicutarium and Equisetum arvense;

Weeds growing in paddy fields such as Echinochloa oryzicola Vasing, Echinochloa crus-galli P. B. var. formosensis Ohwi, Cyperus difformis, Cyperus iria, Fimbristylis miliacea, Eleocharis acicularis, Scirpus juncoides, Scirpus wallichii, Cyperus serotinas, Eleocharis kuroguwai, Scirpus planiculmis, Scirpus nipponicus, Monochoria vaginalis, Lindernia procumbens, Dopatrium junceum, Rotala indica, Ammannia multiflora, Elatine triandra, Ludwigia prostrata, Sagittaria pygmaea, Alisma canaliculatum, Sagittaria trifolia, Potamogeton distinctus, Oenanthe javanica, Callitriche palustris, Lindernia angustifolia, Lindernia dubia, Eclipta prostrata, Murdannia keisak, Paspalumdistichum and Leersia oryzoides.

The herbicidal composition of the present invention can be used as an herbicide for farmlands or non-farmlands such as dry field, paddy field, and turf and fruit orchard. The herbicidal composition of the present invention can control weeds growing in the farmlands for crop cultivation, without phytotoxicity to the crops. The crops are as follows.

Agricultural crops: corn, rice, wheat, barley, rye, oat, sorghum, cotton, soybean, peanut, sarrazin, sugar beet, rapeseed, sunflower, sugar cane, tobacco etc.;

Vegetables: Solanaceae vegetables (eggplant, tomato, green pepper, hot pepper, potato etc.), Cucurbitaceae vegetables (cucumber, pumpkin, zucchini, watermelon, melon etc.), Cruciferae vegetables (Japanese radish, turnip, horseradish, kohlrabi, Chinese cabbage, cabbage, brown mustard, broccoli, cauliflower etc.), Compositae vegetables (burdock, garland chrysanthemum, artichoke, lettuce etc.), Liliaceae vegetables (Welsh onion, onion, garlic, asparagus etc.), Umbelliferae vegetables (carrot, parsley, celery, parsnip etc.), Chenopodiaceae vegetables (spinach, Swiss chard etc.), Labiatae vegetables (Japanese basil, mint, basil etc.), strawberry, sweat potato, yam, aroid etc.;

Flowers and ornamental plants;

Foliage plants;

Fruit trees: pomaceous fruits (apple, common pear, Japanese pear, Chinese quince, quince etc.), stone fleshy fruits (peach, plum, nectarine, Japanese plum, cherry, apricot, prune etc.), citrus plants (Satsuma mandarin, orange, lemon, lime, grapefruit etc.), nuts (chestnut, walnut, hazel nut, almond, pistachio, cashew nut, macadamia nut etc.), berry fruits (blueberry, cranberry, blackberry, raspberry etc.), grape, persimmon, olive, loquat, banana, coffee, date, coconut etc.;

Trees other than fruit trees: tea, mulberry, flowering trees and shrubs, street trees (ash tree, birch, dogwood, eucalyptus, ginkgo, lilac, maple tree, oak, poplar, cercis, Chinese sweet gum, plane tree, zelkova, Japanese arborvitae, fir tree, Japanese hemlock, needle juniper, pine, spruce, yew) etc.

The above “crops” include those having herbicide resistance conferred by a classical breeding method, a genetic engineering technique, or the like. Examples of the herbicide to be resisted include HPPD inhibitors such as isoxaflutole, ALS inhibitors such as imazethapyr or thifensulfuron-methyl; EPSP synthase inhibitors; glutamine synthetase inhibitors; acetyl CoA carboxylase inhibitors; bromoxynil; dicamba; and the like.

Examples of the “crops” having herbicide resistance conferred by a classical breeding method include Clearfield (registered trademark) canola resistant to imidazolinone herbicides such as imazethapyr, and STS soybean resistant to sulfonylurea herbicides such as thifensulfuron-methyl, and the like. Similarly, examples of the crops having herbicide resistance conferred by a classical breeding method includes SR corn resistant to acetyl CoA carboxylase inhibitors such as trione oxime herbicides and aryloxyphenoxypropionic acid herbicides, and the like. The crops having herbicide resistance to an acetyl CoA carboxylase inhibitor are described in Proc. Natl. Acad. Sci. USA), Vol. 87, pp. 7175-7179, 1990, and the like. In addition, mutant acetyl CoA carboxylase resistant to acetyl CoA carboxylase inhibitors is reported in Weed Science 53: p. 728-746, 2005, and the like. When such a gene encoding the mutant acetyl CoA carboxylase is introduced into a crop by genetic engineering techniques or when mutations related to acetyl CoA carboxylase inhibitor-resistance are introduced into the gene encoding acetyl CoA carboxylase of the crops, the crops having the resistance to acetyl CoA carboxylase inhibitors can be produced.

Examples of the “crop” having herbicide resistance conferred by genetic engineering techniques include corn cultivars having resistance to glyphosate or glufosinate.

Some of such corn cultivars are sold under the trade name of RoundupReady (registered trademark), LibertyLink (registered trademark), and the like.

The above “crops” include those having an ability to produce, for example, selective toxins originated from Bacillus which ability has been imparted by genetic engineering techniques.

Examples of the insecticidal toxins which are produced by such genetically engineered plants include insecticidal proteins derived from Bacillus cereus and Bacillus popilliae; δ-endotoxins derived from Bacillus thuringiensis, such as Cry1Ab, Cry1Ac, Cry1F, Cry1Fa2, Cry2Ab, Cry3A, Cry3Bb1 and Cry9C; insecticidal proteins derived from Bacillus thuringiensis, such as VIP 1, VIP 2, VIP 3 and VIP 3A; insecticidal proteins derived from nematodes; toxins produced by animals such as scorpion toxins, spider toxins, bee toxins and insect-specific nerve toxins; fungal toxins; plant lectins; agglutinins; protease inhibitors such as trypsin inhibitors, serine protease inhibitors, patatin, cystatin, and papain inhibitors; ribosome-inactivating proteins (RIP) such as ricins, corn-RIP, abrins, saporins, and briodin; steroid metabolizing enzymes such as 3-hydroxysteroid oxidase, ecdysteroid-UDP-glucosyltransferase, and cholesterol oxidase; ecdysone inhibitors; HMG-CoA reductase; ion channel inhibitors such as sodium channel inhibitors and calcium channel inhibitors; juvenile hormone esterase; diuretic hormone receptors; stilbene synthase; bibenzyl synthase; chitinase; and glucanase.

The insecticidal toxins produced by such genetically engineered plants also include hybrid toxins of different insecticidal proteins, for example, δ-endotoxins such as Cry1Ab, Cry1Ac, Cry1F, Cry1Fa2, Cry2Ab, Cry3A, Cry3Bb1 and Cry9C and insecticidal proteins such as VIP 1, VIP 2, VIP 3 and VIP 3A, and toxins in which a part of amino acids constituting insecticidal proteins is deleted or modified. The hybrid toxins are made by combining different domains of the insecticidal proteins by genetic engineering techniques. An example of the toxin in which a part of amino acids constituting an insecticidal protein is deleted includes Cry1Ab in which a part of amino acids is deleted. An example of the toxin in which a part of amino acids constituting an insecticidal protein is modified includes a toxin in which one or more of amino acids of a natural toxin are substituted.

The insecticidal toxin and the genetically engineered crops having the ability to produce the insecticidal toxins are described, for example, in EP-A-0 374 753, WO 93/07278, WO 95/34656, EP-A-0 427 529, EP-A-451878, WO 03/052073, and the like.

The genetically engineered crops having the ability to produce the insecticidal toxins particularly have resistance to attack by Coleopteran pests, Dipteran pests or Lepidopteran pests.

Genetically engineered crops which have one or more pest-resistance genes and thereby produce one or more insecticidal toxins are also known, and some of them are commercially available. Examples of such genetically engineered crops include YieldGard (registered trademark) (a corn cultivar expressing Cry1Ab toxin), YieldGard Rootworm (registered trademark) (a corn cultivar expressing Cry3Bb1 toxin), YieldGard Plus (registered trademark) (a corn cultivar expressing Cry1Ab and Cry3Bb1 toxins), Heculex I (registered trademark) (a corn cultivar expressing Cry1Fa2 toxin and phosphinothricin N-acetyltransferase (PAT) to confer resistance to glufosinate), NuCOTN33B (registered trademark) (a cotton cultivar expressing Cry1Ac toxin), Bollgard I (registered trademark) (a cotton cultivar expressing Cry1Ac toxin), Bollgard II (registered trademark) (a cotton cultivar expressing Cry1Ac and Cry2Ab toxins), VIPCOT (registered trademark) (a cotton cultivar expressing VIP toxin), NewLeaf (registered trademark) (a potato cultivar expressing Cry3A toxin), NatureGard (registered trademark), Agrisure GT Advantage (registered trademark) (GA21 glyphosate-resistance trait), Agrisure CB Advantage (registered trademark) (Bt11 corn borer (CB) trait), Protecta (registered trademark), and the like.

The above “crops” include those to which ability to produce anti-pathogen substances have been conferred by genetic engineering techniques.

Examples of the anti-pathogen substances include PR proteins (PRPs described in EP-A-0 392 225); ion channel inhibitors such as sodium channel inhibitors, and calcium channel inhibitors (e.g. KP1, KP4, KP6 toxins etc. produced by viruses); stilbene synthase; bibenzyl synthase; chitinase; glucanase; substances produced by microorganisms such as peptide antibiotics, heterocycle-containing antibiotics, and protein factors involved in plant disease-resistance described in WO 03/000906; and the like. Such anti-pathogen substances and genetically engineered crops which produce the anti-pathogen substances are described in EP-A-0 392 225, WO 05/33818, EP-A-0 353 191, and the like.

Usually, the herbicidal composition of the present invention is formulated into a form suitable for an intended purpose. That is, the active ingredients of the herbicidal composition of the present invention are dissolved or dispersed in an appropriate liquid carrier, mixed with an appropriate solid carrier, or adsorbed in an appropriate solid carrier before use to formulate into a form such as emulsifiable concentrate, liquid formulation, oil solution, aerosol, wettable powder, dust, DL (driftless) dust, granule, microgranule, microgranule F, fine granule F, water dispersible granule, water-soluble formulation, flowable formulation, dry flowable formulation, jumbo tablet which means bagged self-diffusible powder, tablet, paste, and the like. These formulations are prepared according to a known method, if necessary, by adding auxiliary agents for formulations such as emulsifier, dispersant, spreading agent, penetrant, moistening agent, binder, thickener, preservative, antioxidant, colorant and the like.

Examples of the liquid carrier to be used for the formulation include water, alcohols (e.g. methanol, ethanol, 1-propanol, 2-propanol and ethylene glycol), ketones (e.g. acetone and methyl ethyl ketone), ethers (e.g. dioxane, tetrahydrofuran, ethylene glycol monomethyl ether, diethylene glycol monomethyl ether and propylene glycol monomethyl ether), aliphatic hydrocarbons (e.g. hexane, octane, cyclohexane, kerosene, fuel oil and machine oil), aromatic hydrocarbons (e.g. benzene, toluene, xylene, solvent naphtha and methyl naphthalene), halogenated hydrocarbons (e.g. dichloromethane, chloroform and carbon tetrachloride), acid amides (e.g. dimethylformamide, dimethylacetamide and N-methylpyrrolidone), esters (e.g. ethyl acetate, butyl acetate and fatty acid glycerin ester) and nitriles (e.g. acetonitrile and propionitrile). These liquid carriers can be used alone or in combination by mixing two or more kinds thereof in an appropriate ratio.

Examples of the solid carrier to be used for the formulation include vegetable powders (e.g. soybean powder, tobacco powder, wheat flour and wood flour), mineral powders (e.g. clays such as kaolin, bentonite, acidic white clay and clay, talcs such as talcum powder and pyrophyllite, silicas such as diatom earth and mica), alumina, sulfur powder, active carbon, saccharides (e.g., lactose and glucose), inorganic salts (e.g., calcium carbonate and sodium bicarbonate) and glass hollow materials (prepared by subjecting natural glass to calcination processing to encapsulate bubbles therein). These solid carriers can be used alone or in combination by mixing two or more kinds thereof in an appropriate ratio.

The liquid carrier or solid carrier is usually used in a ratio of 1 to 99% by weight, preferably from about 10 to 99% by weight, based on the entire formulation.

Usually, a surfactant is used as the emulsifier, dispersant, spreading agent, penetrant and moistening agent to be used for the formulation. Examples of the surfactant include anionic surfactants such as alkyl sulfate, alkylaryl sulfonate, dialkyl sulfosuccinate, polyoxyethylene alkylaryl ether phosphate, lignin sulfonate and naphthalene sulfonate-formaldehyde polycondensate; and non-ionic surfactants such as polyoxyethylene alkyl ether, polyoxyethylene alkylaryl ether, polyoxyethylene alkyl polyoxypropylene block copolymers and sorbitan fatty acid ester. These surfactants can be used alone or in combination with two or more kinds thereof. The surfactant is usually used in a ratio of 0.1 to 50% by weight, preferably from about 0.1 to 25% by weight, based on the entire formulation.

Examples of the binder and thickener include dextrin, sodium salts of carboxymethyl cellulose, polycarboxylic acid-based polymer compounds, polyvinyl pyrrolidone, polyvinyl alcohol, sodium lignin sulfonate, calcium lignin sulfonate, sodium polyacrylate, gum arabic, sodium alginate, mannitol, sorbitol, bentonite-based mineral substances, polyacrylic acid and the derivatives, sodium salt of carboxymethyl cellulose, white carbon, natural saccharide derivatives (e.g., xanthan gum and guar gum).

The total amount of the active ingredients of the herbicidal composition of the present invention contained in the formulation is usually from 1 to 90% by weight based on the entire formulation in the case of the emulsifiable concentrate, wettable powder, water dispersible granule, liquid formulation, water-soluble formulation, flowable formulation and the like, from 0.01 to 10% by weight based on that of the entire formulation in the case of the oil solution, dust, DL dust and the like, and from 0.05 to 10% by weight based on that of the entire formulation in the case of the microgranule, microgranule F, fine granule F, granule and the like. However, these concentrations can be appropriately adjusted depending on an intended purpose. Usually, the formulations such as emulsifiable concentrate, wettable powder, water dispersible granule, liquid formulation, water-soluble formulation and flowable formulation are appropriately diluted with water before use by about 100 to 100,000 times.

In the herbicidal composition of the present invention, a mixing ratio of the present compound to glyphosate or an agriculturally acceptable salt thereof to be used as the active ingredients is in a range from 1:0.01 to 1:1000, and preferably from 1:0.1 to 1:100 by weight.

In the herbicidal composition of the present invention, a mixing ratio of the present compound to metolachloror an optically active isomer thereof to be used as the active ingredients is in a range from 1:0.01 to 1:100, and preferably from 1:0.1 to 1:100 by weight.

In the herbicidal composition of the present invention, a mixing ratio of the present compound to acetochlor to be used as the active ingredients is in a range from 1:0.01 to 1:100, and preferably from 1:0.1 to 1:100 by weight.

In the herbicidal composition of the present invention, a mixing ratio of the present compound to atrazine to be used as the active ingredients is in a range from 1:0.01 to 1:100, and preferably from 1:0.1 to 1:100 by weight.

In the herbicidal composition of the present invention, a mixing ratio of the present compound to dicamba to be used as the active ingredients is in a range from 1:0.01 to 1:100, and preferably from 1:0.1 to 1:100 by weight.

In the herbicidal composition of the present invention, a mixing ratio of the present compound to 2,4-D or an agriculturally acceptable salt or ester thereof to be used as the active ingredients is in a range from 1:0.1 to 1:100, and preferably from 1:0.5 to 1:20 by weight.

The herbicidal composition of the present invention can be also prepared by preparing formulations of the respective active ingredients by means of the above formulation method, followed by mixing them.

The application method for the herbicidal composition of the present invention can be the same as that for known agrochemicals, such as aerial spray, soil spray and foliage spray.

When the herbicidal composition of the present invention is used as a herbicide for field or paddy field, the amount thereof to be used is usually about 1 to 5,000 g, preferably from 10 to 1,000 g, per hectare of the field or paddy field in terms of a total amount of the active ingredients contained in the herbicidal composition of the present invention. However, the amount may fluctuate depending on application area, application period, application method, variety of target weeds and cultivation crops and the like.

The herbicidal composition of the present invention is usually used as that for pre-emergence soil incorporation treatment, pre-emergence soil treatment or post-emergence foliar treatment in the case of weed control of dry fields. It is usually used for flooding soil treatment or foliage and soil treatment in the case of weed control of paddy fields.

Further, it can be expected to enhance the weed control effect of the herbicidal composition of the present invention by mixing or concomitant use with one or more other herbicides. It is also possible to mix or use concomitantly with one or more of nematocide, fungicide, plant growth regulator, safener, fertilizer, soil conditioner and the like.

The mixing ratio of the herbicidal composition of the present invention to a herbicide to be mixed or concomitantly used is usually from 1:0.01 to 1:100, and preferably from 1:0.1 to 1:10, in terms of the active ingredients by weight.

The mixing ratio of the herbicidal composition of the present invention to an insecticide to be mixed or concomitantly used is usually from 1:0.01 to 1:100, and preferably from 1:0.1 to 1:10, in terms of the active ingredients by weight.

The mixing ratio of the herbicidal composition of the present invention to a fungicide to be mixed or concomitantly used is usually from 1:0.01 to 1:100, and preferably from 1:0.1 to 1:10, in terms of the active ingredients by weight.

The mixing ratio of the herbicidal composition of the present invention to a plant growth regulator to be mixed or concomitantly used is usually from 1:0.00001 to 1:100, and preferably from 1:0.0001 to 1:1, in terms of the active ingredients by weight.

The mixing ratio of the herbicidal composition of the present invention to a safener to be mixed or concomitantly used is usually from 1:0.001 to 1:100, and preferably from 1:0.01 to 1:10, in terms of the active ingredients by weight.

The mixing ratio of the herbicidal composition of the present invention to a fertilizer to be mixed or concomitantly used is usually from 1:0.1 to 1:1000, and preferably from 1:1 to 1:200, in terms of the active ingredients by weight.

Examples of active ingredients of other herbicides that can be used in or together with the herbicidal composition of the present invention include:

(1) herbicidal phenoxyfatty acid compounds (e.g. MCP, MCPS, phenothiol, mecoprop, fluoroxypyr, triclopyr, clomeprop, naproanilide, etc.),
(2) herbicidal benzoate compounds (e.g. 2,3,6-TBA, clopyrald, picloram, aminopyralid, quinclorac, quinmerac, etc.),
(3) herbicidal urea compounds (diuron, linuron, chlortoluron, isoproturon, fluometuron), isouron, tebuthiuron, methabenzthiazuron, cumyluron, daimuron, methyl-daimuron, etc.),
(4) herbicidal triazine compounds (e.g. ametoryn, cyanazine, simazine, propazine, simetryn, dimethametryn, prometryn, metribuzin, triaziflam, etc.),
(5) herbicidal bipyridinium compounds (e.g. paraquat, diquat, etc.),
(6) herbicidal hydroxybenzonitrile compounds (e.g. bromoxynil, ioxynil, etc.),
(7) herbicidal dinitroaniline compounds (e.g. pendimethalin, prodiamine, trifluralin, etc.),
(8) herbicidal organophosphorous compounds (e.g. amiprofos-methyl, butamifos, bensulide, piperophos, anilofos, glufosinate, bialaphos, etc.),
(9) herbicidal carbamate compounds (e.g. di-allate, tri-allate, EPTC, butylate, benthiocarb, esprocarb, molinate, dimepiperate, swep, chlorpropham, phenmedipham, phenisopham, pyributicarb, asulam, etc.),
(10) herbicidal acid amide compounds (e.g. propanil, propyzamide, bromobutide, etobenzanid, etc.),
(11) herbicidal chloroacetanilide compounds (e.g. alachlor, butachlor, dimethenamid, propachlor, metazachlor, pretilachlor, thenylchlor, pethoxamid, etc.),
(12) herbicidal diphenylether compounds (e.g. acifluorfen-sodium, bifenox, oxyfluorfen, lactofen, fomesafen, chlomethoxynil, aclonifen, etc.),
(13) herbicidal cyclicimide compounds (e.g. oxadiazon, cinidon-ethyl, carfentrazone-ethyl, surfentrazone, flumiclorac-pentyl, pyraflufen-ethyl, oxadiargyl, pentoxazone, fluthiacet-methyl, butafenacil, benzfendizone, etc.),
(14) herbicidal pyrazole compounds (e.g. benzofenap, pyrazolate, pyrazoxyfen, topramezone, pyrasulfotole, etc.),
(15) herbicidal triketone compounds (e.g. isoxaflutole, benzobicyclon, sulcotrione, mesotrione, tembotrione, tefuryltrione, etc.),
(16) herbicidal aryloxyphenoxypropionate compounds (e.g. cyhalofop-butyl, diclofop-methyl, fenoxaprop-ethyl, fluazifop-butyl, haloxyfop-methyl, quizalofop-ethyl, metamifop, etc.),
(17) herbicidal trioneoime compounds (e.g. alloxydim-sodium, sethoxydim, butroxydim, clethodim, cloproxydim, cycloxydim, tepraloxydim, tralkoxydim, profoxydim, etc.),
(18) herbicidal sulfonylurea compounds (e.g. chlorsulfuron, sulfometuron-methyl, metsulfuron-methyl, tribenuron-methyl, triasulfuron, bensulfuron-methyl, thifensulfuron-methyl, pyrazosulfuron-ethyl, primisulfuron-methyl, nicosulfuron, amidosulfuron, cinosulfuron, imazosulfuron, rimsulfuron, halosulfuron-methyl, prosulfuron, ethametsulfuron-methyl, triflusulfuron-methyl, flazasulfuron, cyclosulfamuron, flupyrsulfuron, sulfosulfuron, azimsulfuron, ethoxysulfuron, oxasulfuron, iodosulfuron-methyl-sodium, foramsulfuron, mesosulfuron-methyl, trifloxysulfuron, tritosulfuron, orthosulfamuron, flucetosulfuron, etc.),
(19) herbicidal imidazolinone compounds (e.g. imazamethabenz-methyl, imazamethapyr, imazamox, imazapyr, imazaquin), imazethapyr, etc.),
(20) herbicidal sulfoneamide compounds (e.g. flumetsulam, metosulam, diclosulam, florasulam, penoxsulam, pyroxsulam, etc.),
(21) herbicidal pyrimidinyloxybenzoate compounds (e.g. pyrithiobac-sodium, bispyribac-sodium, pyriminobac-methyl, pyribenzoxim, pyriftalid, pyrimisulfan, etc.), and
(22) other herbicidal compounds (e.g. bentazon, bromacil, terbacil, chlorthiamid, isoxaben, dinoseb, amitrole, cinmethylin, tridiphane, dalapon, diflufenzopyr-sodium, dithiopyr, thiazopyr, flucarbazone-sodium, propoxycarbazone-sodium, mefenacet, flufenacet, fentrazamide, cafenstrole, indanofan, oxaziclomefone, benfuresate, ACN, pyridate, chloridazon, norflurazon, flurtamone, diflufenican, picolinafen, beflubutamid, clomazone, amicarbazone, pyraclonil, pyroxasulfone, thiencarbazone-methyl, etc.) and the like.

Examples of active ingredients of plant growth regulators include hymexazol, paclobutrazol, uniconazole-P, inabenfide, prohexadione-calcium, and the like.

Examples of active ingredients of fungicides include:

(1) fungicidal polyhaloalkylthio compounds (e.g. captan, etc.),
(2) fungicidal organophosphorous compounds (e.g. IBP, EDDP, tolclofos-methyl, etc.),
(3) fungicidal benzimidazole compounds (e.g. benomyl, carbendazim, thiophanate-methyl, etc.),
(4) fungicidal carboxyamide compounds (e.g. carboxin, mepronil, flutolanil, thifluzamid, furametpyr, boscalid, penthiopyrad, etc.),
(5) fungicidal dicarboxylmide compounds (e.g. procymidone, iprodione, vinclozolin, etc.),
(6) fungicidal acylalanine compounds (e.g. metalaxyl, etc.),
(7) fungicidal azole compounds (e.g. triadimefon, triadimenol, propiconazole, tebuconazole, cyproconazole, epoxiconazole, prothioconazole, ipconazole, triflumizole, prochloraz, etc.),
(8) fungicidal morphorine compounds (e.g. dodemorph, tridemorph, fenpropimorph, etc.),
(9) fungicidal strobilphosphorus compounds (e.g. azoxystrobin, kresoxim-methyl, metominostrobin, trifloxystrobin, picoxystrobin, pyraclostrobin, etc.),
(10) fungicidal antibiotic compounds (e.g. validamycin A, blasticidin S, kasugamycin, polyoxin, etc.),
(11) fungicidal sithiocarbamate compounds (e.g. mancozeb, maneb, etc.), and
(12) other fungicidal compounds (e.g. fthalide, probenazole, isoprothiolane, tricyclazole, pyroquilon, ferimzone, acibenzolar S-methyl, carpropamid, diclocymet, fenoxanil, tiadinil, diclomezine, teclofthalam, pencycuron, oxolinic acid, TPN, triforine, fenpropidin, spiroxamine, fluazinam, iminoctadine, fenpiclonil, fludioxonil, quinoxyfen, fenhexamid, silthiofam, proquinazid, cyflufenamid, basic calcium copper sulfate (bordeaux mixture, etc.), and the like.

Examples of active ingredients of insecticides include

(1) insecticidal organophosphorous compounds (e.g. fenthion, fenitrothion, pirimiphos-methyl, diazinon, quinalphos), isoxathion, pyridafenthion, chlorpyrifos-methyl, vamidothion, malathion, phenthoate, dimethoate, disulfoton, monocrotophos, tetrachlorvinphos, chlorfenvinphos, propaphos, acephate, trichlorphon, EPN, pyraclofos, etc.),
(2) insecticidal carbamate compounds (e.g. carbaryl, metolcarb, isoprocarb, BPMC, propoxur, XMC, carbofuran, carbosulfan, benfuracarb, furathiocarb, methomyl, thiodicarb, etc.),
(3) insecticidal synthetic pyrethroid compounds (e.g. tefluthrin, bifenthrin, cycloprothrin, ethofenprox, etc.),
(4) insecticidal nereistoxin compounds (e.g. cartap, bensultap, thiocyclam, etc.),
(5) insecticidal neonicotinoid compounds (e.g. imidacloprid, nitenpyram, acetamiprid, thiamethoxam, thiacloprid, dinotefuran, clothianidin, etc.),
(6) insecticidal benzoylphenyurea compounds (e.g. chlorfluazuron, flufenoxuron, hexaflumuron, lufenuron, novaluron, etc.),
(7) insecticidal macrolide compounds (e.g. emamectin, spinosad, etc.), and
(8) other insecticidal compounds (e.g. buprofezin, tebufenozide, fipronil, ethiprole, pymetrozine, diafenthiuron, indoxacarb, tolfenpyrad, pyridalyl, flonicamid, flubendiamide, rynaxypyr, cyazypyr, etc.), and the like.

Examples of acaricides include hexythiazox, pyridaben, fenpyroximate, tebufenpyrad, chlorfenapyr, etoxazole, pyrimidifen, acequinocyl, bifenazate, spirodiclofen, and the like.

Examples of active ingredients of nematocides include fosthiazate, cadusafos, and the like.

Examples of fertilizers include nitrogen fertilizers such as urea, and the like.

Herbicides containing the composition of the present invention as an active ingredient may further appropriately contain safeners (e.g. furilazole, dichlormid, benoxacor, allidochlor, isoxadifen-ethyl, fenclorim, cyprosulfamide, cyometrinil, oxabetrinil, fluxofenim, flurazole, 1,8-naphthalic anhydride, etc.), pigments, and the like.

The present compound can be prepared, for example, by the following production methods.

### Production Method 1

Among the present compounds, the compound represented by the general formula (I-a), i.e., the present compound wherein G is a hydrogen atom, can be prepared by reacting a compound represented by the general formula (II) with a metal hydroxide.

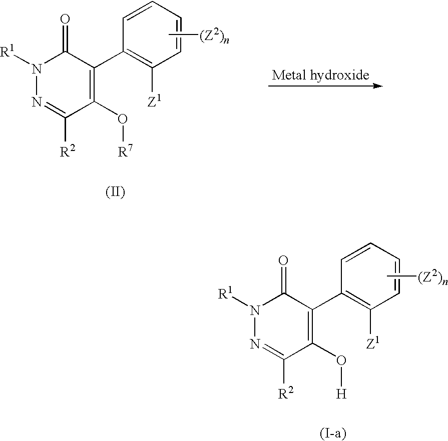

wherein R⁷ represents a C₁₋₆ alkyl group (e.g., a methyl or ethyl group); and R¹, R², Z¹, Z² and n are as defined above.

This reaction is usually carried out in a solvent. Examples of the solvent include water; ether solvents such as tetrahydrofuran and dioxane; and a mixed solvent thereof.

Examples of the metal hydroxide to be used in this reaction include alkali metal hydroxides such as sodium hydroxide and potassium hydroxide. The amount of the metal hydroxide to be used is usually from 1 to 120 molar equivalents, preferably from 1 to 40 molar equivalents relative to the compound represented by the general formula (II).

The reaction temperature of this reaction is usually in a range from room temperature to a boiling point of a solvent to be used, and preferably a boiling point of the solvent. This reaction can be also carried out in a sealed tube or a pressure-resistant airtight container with heating. The reaction time of this reaction is usually from 5 minutes to a few of weeks.

The completion of this reaction can be confirmed by sampling the reaction mixture and identifying the product by an analytic means such as thin layer chromatography (TLC), high performance liquid chromatography (HPLC), etc. After completion of the reaction, the compound represented by the general formula (I-a) can be isolated, for example, by neutralizing the reaction mixture with an acid, mixing with water and extracting with an organic solvent, followed by subjecting the resultant organic layer to operations such as drying and concentration.

### Production Method 2

Among the present compounds, a compound represented by the general formula (I-b), i.e. the present compound wherein G is a group other than a hydrogen atom, can be prepared by reacting the compound represented by the general formula (I-a) with a compound represented by the general formula (III).

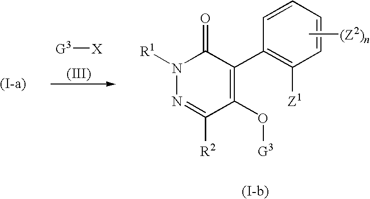

wherein G³ represents a group defined by G excluding a hydrogen atom; X represents a halogen atom (e.g., a chlorine atom, abromine atom or an iodine atom) or a group represented by OG³; and R¹, R², Z¹, Z² and n are as defined above.

This reaction can be carried out in a solvent. Examples of the solvent to be used include aromatic hydrocarbons such as benzene and toluene; ethers such as diethyl ether, diisopropyl ether, dioxane, tetrahydrofuran and dimethoxyethane; halogenated hydrocarbons such as dichloromethane, chloroform and 1,2-dichloroethane; amides such as dimethylformamide and dimethylacetamide; sulfoxides such as dimethyl sulfoxide; sulfones such as sulfolane; and a mixed solvent thereof.

Examples of the compound represented by the general formula (III) to be used in this reaction include carboxylic acid halides such as acetyl chloride, propionyl chloride, isobutyryl chloride, pivaloyl chloride, benzoyl chloride and cyclohexane carboxylic acid chloride; carboxylic anhydrides such as acetic anhydride and trifluoroacetic anhydride; carbonic half ester halides such as chloroformic acid methyl, chloroformic acid ethyl and chloroformic acid phenyl; carbamic acid halides such as dimethylcarbamoyl chloride; sulfonic acid halides such as methanesulfonyl chloride and p-toluenesulfonyl chloride; sulfonic anhydrides such as methanesulfonic anhydride and trifluoromethanesulfonic anhydride; and phosphoric ester halides such as dimethyl chlorophosphate. The amount of the compound represented by the general formula (III) to be used in this reaction is usually 1 molar equivalent or more, preferably from 1 to 3 molar equivalents relative to the compound represented by the general formula (I-a).

This reaction is usually carried out in the presence of a base. Examples of the base to be used in this reaction include organic bases such as triethylamine, tripropylamine, pyridine, dimethylaminopyridine and 1,8-diazabicyclo[5.4.0]-7-undecene; and inorganic bases such as sodium hydroxide, potassium hydroxide, calcium hydroxide, sodium carbonate, potassium carbonate, sodium hydrogen carbonate, calcium carbonate and sodium hydride. The amount of the base to be used in this reaction is usually from 0.5 to 10 molar equivalents, and preferably from 1 to 5 molar equivalents relative to the compound represented by the general formula (I-a).

The reaction temperature of this reaction is usually from −30 to 180° C., preferably from −10 to 50° C., and the reaction time is usually from 10 minutes to 30 hours.

The completion of this reaction can be confirmed by sampling the reaction mixture and identifying the product by an analytic means such as TLC, HPLC, etc. After completion of the reaction, the compound represented by the general formula (I-b) can be isolated, for example, by mixing the reaction mixture with water and extracting with an organic solvent, followed by subjected to the resulting organic layer to operations such as drying and concentration.

The compound represented by the general formula (III) is a known compound, or can be prepared from a known compound.

### Production Method 3

Among the present compounds, the compound represented by the general formula (I-a), i.e., the present compound wherein G is a hydrogen atom, can be also prepared by the following production method. That is, the compound represented by the general formula (I-a) can be prepared by reacting a compound represented by the general formula (VI) with a base.

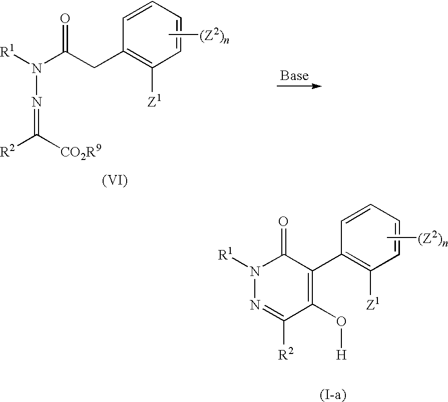

wherein R⁹ represents a C₁₋₆ alkyl group (e.g., a methyl group or an ethyl group; and R¹, R², Z¹, Z² and n are as defined above.

This reaction is usually carried out in a solvent. Examples of the solvent to be used include aromatic hydrocarbons such as benzene, toluene and xylene; ethers such as diethyl ether, diisopropyl ether, dioxane, tetrahydrofuran and dimethoxyethane; halogenated hydrocarbons such as dichloromethane, chloroform and 1,2-dichloroethane; amides such as dimethylformamide and dimethylacetamide; sulfones such as sulfolane; and a mixed solvent thereof.

Examples of the base to be used in this reaction include metal alkoxides such as potassium tert-butoxide; alkali metal hydride such as sodium hydride; and organic bases such as triethylamine, tributylamine and N,N-diisopropylethylamine. The amount of the base to be used in this reaction is usually from 1 to 10 molar equivalents, and preferably from 2 to 5 molar equivalents relative to the compound represented by the general formula (VI).

The reaction temperature of this reaction is usually from −60 to 180° C., and preferably from −10 to 100° C., and the reaction time is usually from 10 minutes to 30 hours.

The completion of the present reaction can be confirmed by sampling the reaction mixture and identifying the product by an analytic means such as TLC, HPLC, etc.

After completion of the reaction, the compound represented by the general formula (I-a) can be isolated, for example, by neutralizing the reaction mixture with an acid, mixing with water, and extracted with an organic solvent, followed by subjecting the resultant organic layer to operations such as drying and concentration.

### Reference Production Method 1

The compound represented by the general formula (II) can be prepared, for example, by the following production method.

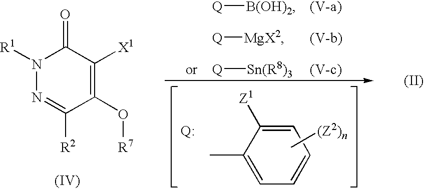

wherein X¹ represents a leaving group (e.g., a halogen atom such as a chlorine atom, a bromine atom or an iodine atom);
X² represents a halogen atom (e.g., a chlorine atom, a bromine atom or an iodine atom); R⁸ represents a C₁₋₆ alkyl group (e.g., a methyl group or a butyl group); and R¹, R², R⁷, Z¹, Z² and n are as defined above.

In this reaction, the compound represented by the general formula (IV) is subjected to coupling reaction with an organic metal reagent represented by the general formula (V-a), (V-b) or (V-c) in an amount of 1 molar equivalent or more (preferably from 1 to 3 molar equivalents) relative to the compound represented by the general formula (IV) to prepare the compound represented by the general formula (II).

The reaction using the compound represented by the general formula (V-a) is usually carried out in a solvent. Examples of the solvent to be used include aromatic hydrocarbons such as benzene and toluene; alcohols such as methanol, ethanol and propanol; ethers such as diethyl ether, diisopropyl ether, dioxane, tetrahydrofuran and dimethoxyethane; ketones such as acetone and methyl ethyl ketone; amides such as dimethylformamide and dimethylacetamide; sulfoxides such as dimethyl sulfoxide; sulfones such as sulfolane; water; and a mixed solvent thereof.

The reaction using the compound represented by the general formula (V-a) is carried out in the presence of a base. Examples of the base to be used include organic bases such as triethylamine, tripropylamine, pyridine, dimethylaniline, dimethylaminopyridine and 1,8-diazabicyclo[5.4.0]-7-undecene; and inorganic bases such as sodium hydroxide, potassium hydroxide, calcium hydroxide, sodium carbonate, potassium carbonate, sodium hydrogen carbonate, calcium carbonate, cesium carbonate and potassium phosphate. The amount of the base to be used is usually from 0.5 to 10 molar equivalents, and preferably from 1 to 5 molar equivalents relative to the compound represented by the general formula (IV).

Further, the reaction using the compound represented by the general formula (V-a) is carried out in the presence of a catalyst. Examples of the catalyst to be used include palladium catalysts such as tetrakis(triphenylphosphine) palladium and dichlorobis(triphenylphosphine) palladium. The amount of the catalyst to be used is usually from 0.001 to 0.5 molar equivalent, and preferably from 0.01 to 0.2 molar equivalent relative to the compound represented by the general formula (IV). It is preferred to add a quaternary ammonium salt to the reaction using the compound represented by the general formula (V-a). Examples of the quaternary ammonium salt to be used include tetrabutylammonium bromide.

The reaction temperature of the reaction using the compound represented by the general formula (V-a) is usually from 20 to 180° C., and preferably from 60 to 150° C. The reaction time is usually from 30 minutes to 100 hours. The completion of the present reaction can be confirmed by sampling the reaction mixture and identifying the product by an analytic means such as TLC, HPLC, etc. After completion of the reaction, the compound represented by the general formula (II) can be isolated, for example, by mixing the reaction mixture with water and extracting with an organic solvent, followed by subjecting the resultant organic layer to operations such as drying and concentration.

The reaction using the compound represented by the general formula (V-b) is carried out in a solvent. Examples of the solvent to be used include aromatic hydrocarbons such as benzene and toluene; ethers such as diethyl ether, diisopropyl ether, dioxane, tetrahydrofuran and dimethoxyethane; and a mixed solvent thereof.

The reaction using the compound represented by the general formula (V-b) is carried out in the presence of a catalyst. Examples of the catalyst to be used include nickel catalysts such as dichlorobis(1,3-diphenylphosphino) propane nickel and dichlorobis(triphenylphosphine) nickel; and palladium catalysts such as tetrakis(triphenylphosphine) palladium and dichlorobis(triphenylphosphine) palladium. The amount of the catalyst to be used is usually from 0.001 to 0.5 molar equivalent, and preferably from 0.01 to 0.2 molar equivalent relative to the compound represented by the general formula (IV).

The reaction temperature of the reaction using the compound represented by the general formula (V-b) is usually from −80 to 180° C., and preferably from −30 to 150° C., and the reaction time is usually from 30 minutes to 100 hours. The completion of the present reaction can be confirmed by sampling the reaction mixture and identifying the product by an analytic means such as TLC, HPLC, etc. After completion of the reaction, the compound represented by the general formula (II) can be isolated, for example, by mixing the reaction mixture with water and extracting with an organic solvent, followed by subjecting the resultant organic layer to operations such as drying and concentration.

The reaction using the compound represented by the general formula (V-c) is carried out in a solvent. Examples of the solvent to be used include aromatic hydrocarbons such as benzene and toluene; ethers such as diethyl ether, diisopropyl ether, dioxane, tetrahydrofuran and dimethoxyethane; halogenated hydrocarbons such as chloroform and 1,2-dichloroethane; amides such as dimethylformamide and dimethylacetamide; and a mixed solvent thereof.

The reaction using the compound represented by the general formula (V-c) is carried out in the presence of a catalyst. Examples of the catalyst to be used include palladium catalysts such as tetrakis(triphenylphosphine) palladium and dichlorobis(triphenylphosphine) palladium. The amount of the catalyst to be used is usually from 0.001 to 0.5 molar equivalent, and preferably from 0.01 to 0.2 molar equivalent relative to the compound represented by the general formula (IV).

The reaction temperature of the reaction using the compound represented by the general formula (V-c) is usually from −80 to 180° C., and preferably from −30 to 150° C., and the reaction time is usually from 30 minutes to 100 hours. The completion of the present reaction can be confirmed by sampling the reaction mixture and identifying the product by an analytic means such as TLC, HPLC. etc. After completion of the reaction, the compound represented by the general formula (II) can be isolated, for example, by mixing the reaction mixture with water and extracting with an organic solvent, followed by subjecting the resultant organic layer to operations such as drying and concentration.

The compound represented by the general formula (II) is prepared, for example, in accordance with a method described in Tetrahedron, Vol. 57, pp. 1323-1330 (2001). The organic metal reagent represented by the general formula (V-a), (V-b) or (V-c) can be a known compound, or can be prepared from a known compound in accordance with a known method.

The compound represented by the general formula (IV) is a known compound, or can be prepared from a known compound. For example, it can be prepared by a method described in J. Heterocycl. Chem., Vol. 33, pp. 1579-1582 (1996), or in accordance with methods similar thereto.

### Reference Production Method 2

The compound represented by the general formula (VI) can be prepared, for example, by the following production method.

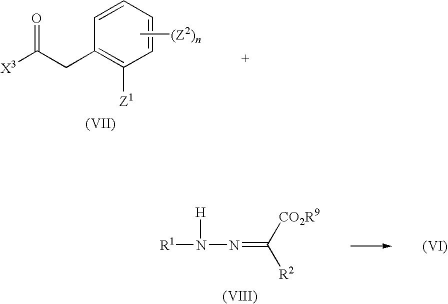

wherein X³ represents a halogen atom (e.g., a chlorine atom, a bromine atom or an iodine atom); and R¹, R², R⁹, Z¹, Z² and n are as defined above.

This reaction is usually carried out in a solvent. Examples of the solvent to be used include nitriles such as acetonitrile; ketones such as acetone; aromatic hydrocarbons such as benzene and toluene; ethers such as diethyl ether, diisopropyl ether, dioxane, tetrahydrofuran and dimethoxyethane; halogenated hydrocarbons such as dichloromethane, chloroform and 1,2-dichloroethane; amides such as dimethylformamide and dimethylacetamide; sulfones such as sulfolane; and a mixed solvent thereof.

This reaction is usually carried out by reacting the compound represented by the general formula (VII) with the compound represented by the general formula (VIII) in the presence of a base. Examples of the base to be used in this reaction include organic bases such as triethylamine, tripropylamine, pyridine, dimethylaminopyridine, 1,8-diazabicyclo[5.4.0]-7-undecene and 1,4-diazabicyclo[2.2.2]octane; and inorganic bases such as sodium hydroxide, potassium hydroxide, calcium hydroxide, sodium carbonate, potassium carbonate, sodium hydrogen carbonate, calcium carbonate and sodium hydride.

In this reaction, the amount of the compound represented by the general formula (VIII) is usually 1 molar equivalent or more, and preferably from 1 to 3 molar equivalents relative to the compound represented by the general formula (VII). The amount of the base to be used is usually from 0.5 to 10 molar equivalents, and preferably from 1 to 5 molar equivalents.

The reaction temperature of this reaction is usually from −30 to 180° C., and preferably from −10 to 50° C., and the reaction time is usually from 10 minutes to 30 hours.

The completion of the present reaction can be confirmed by sampling the reaction mixture and identifying the product by an analytic means such as TLC, HPLC. etc. After completion of the reaction, the compound represented by the general formula (VI) can be isolated, for example, by mixing the reaction mixture with water and extracted with an organic solvent, followed by subjecting the resultant organic layer to operations such as drying and concentration.

The compound represented by the general formula (VII) is prepared by reacting a compound represented by the general formula (IX):

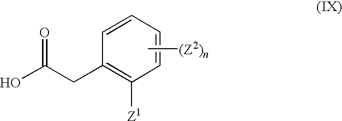

wherein Z¹, Z² and n are as defined above, with a halogenating agent (e.g., thionyl chloride, thionyl bromide, phosphorus oxychloride and oxalyl chloride).

The compound represented by the general formula (IX) is a known compound, or can be prepared from a known compound. For example, it is prepared by the methods described in Organic Syntheses Collective, vol. 3, pp. 557-560 (1955), J. Am. Chem. Soc., Vol. 63, pp. 2643-2644 (1941) or International Publication No. 2006/056282 Pamphlet (WO2006/056282), or in accordance with methods similar thereto. Examples of the compound represented by the general formula (IX) include 2,4,6-trimethylphenylacetic acid, 2,4,6-triethylphenylacetic acid, 2,6-diethyl-4-methylphenylacetic acid, 2-ethylphenylacetic acid, 2-ethyl-4-methylphenylacetic acid, 2-ethyl-4,6-dimethylphenylacetic acid, 2,4-diethylphenylacetic acid, 2,6-diethylphenylacetic acid and 2,4-diethyl-6-methylphenylacetic acid.

The compound represented by the general formula (VIII) is a known compound, or can be prepared from a known compound.

The respective compounds prepared by the Production Methods 1 to 3 and Reference Production Methods 1 and 2 can also be isolated and purified by a known method such as concentration, concentration under reduced pressure, extraction, solvent substitution, crystallization, recrystallization and chromatography, in some cases.

Specific examples of the compound represented by the general formula (I) to be used as the active ingredient of the herbicidal composition of the present invention are shown below.

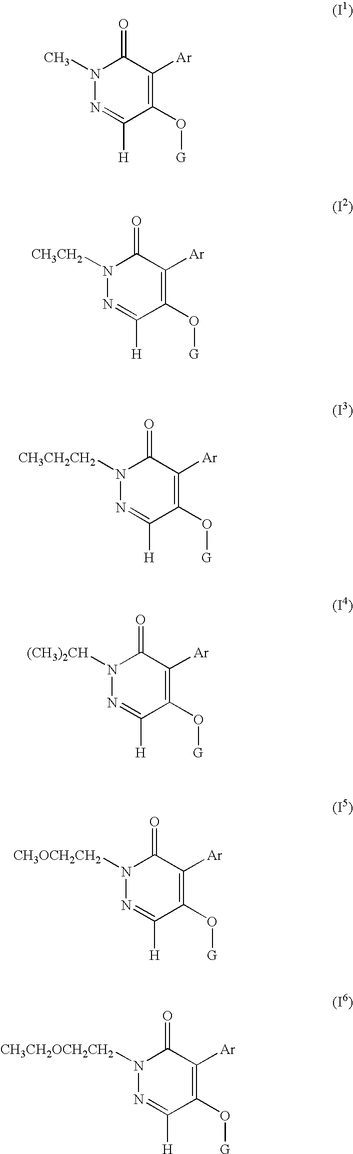

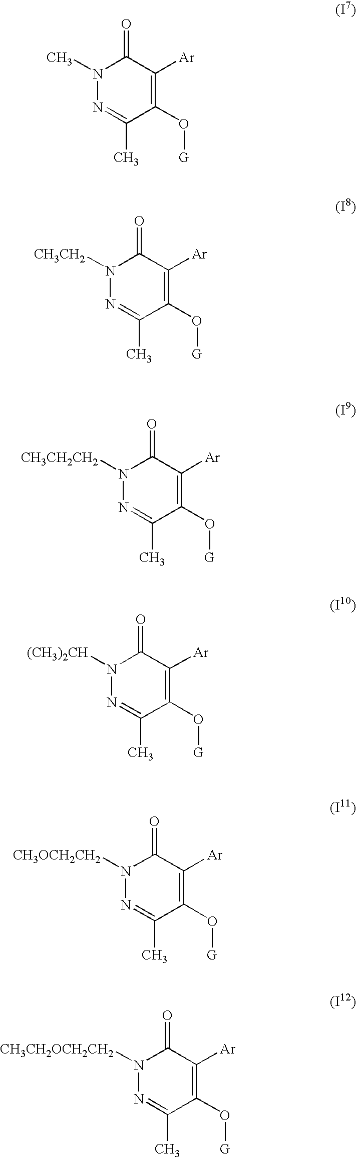

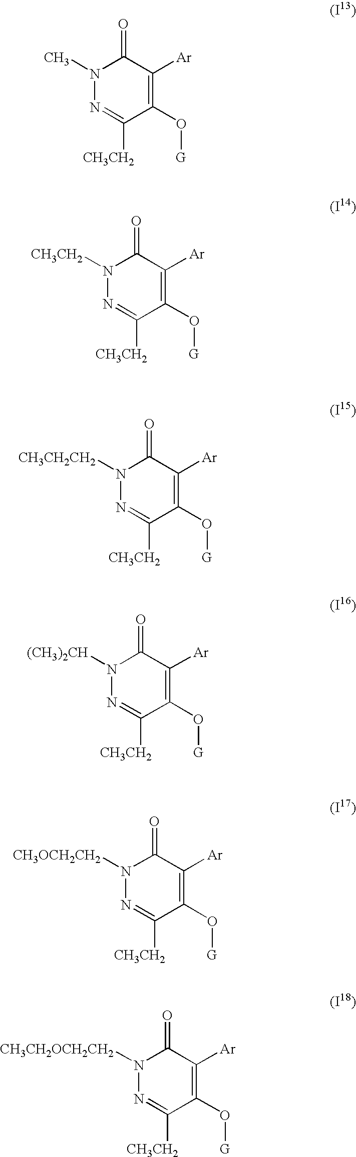

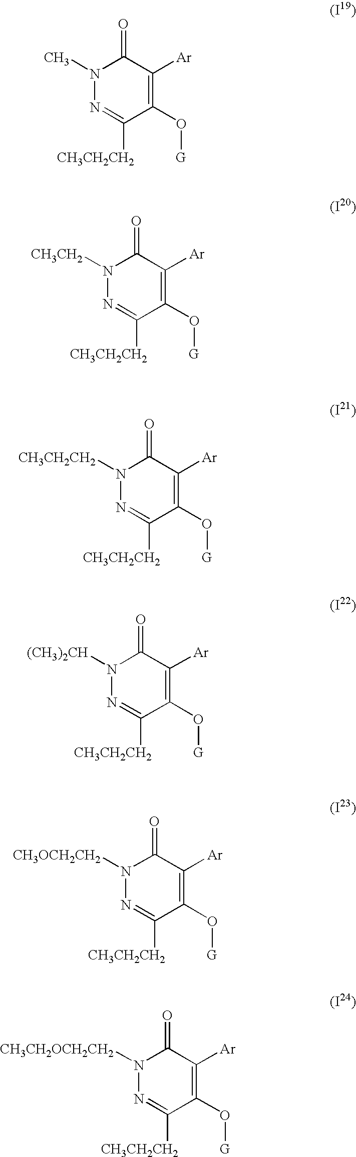

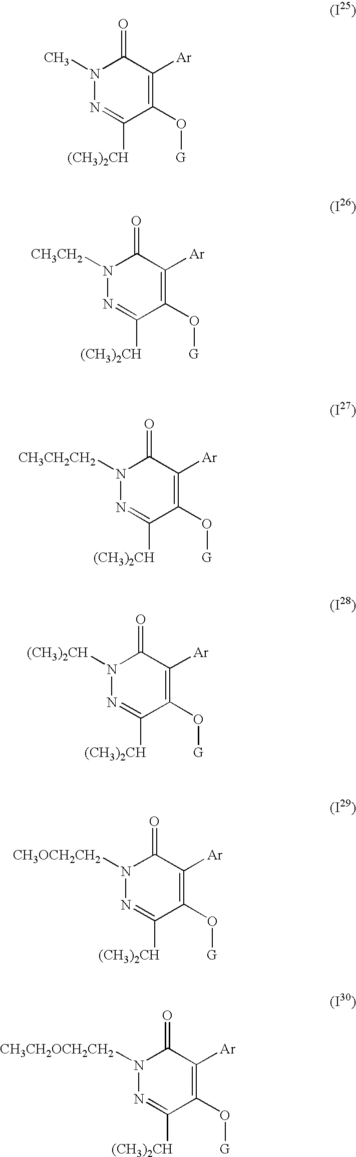

1) The pyridazinone compounds represented by the general formulas (I¹) to (I³⁰), wherein Ar represents a 2-ethylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
2) The pyridazinone compounds represented by the general formulas (I¹) to (I³⁰), wherein Ar represents a 2-propylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
3) The pyridazinone compounds represented by the general formulas (I¹) to (I³⁰), wherein Ar represents a 2,4-dimethylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
4) The pyridazinone compounds represented by the general formulas (I¹) to (I³⁰), wherein Ar represents a 2,6-dimethylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
5) The pyridazinone compounds represented by the general formulas (I¹) to (I³⁰), wherein Ar represents a 2-ethyl-4-methylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
6) The pyridazinone compounds represented by the general formulas (I¹) to (I³⁰), wherein Ar represents a 2-ethyl-6-methylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
7) The pyridazinone compounds represented by the general formulas (I¹) to (I³⁰), wherein Ar represents a 2,6-diethylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
8) The pyridazinone compounds represented by the general formulas (I¹) to (I³⁰), wherein Ar represents a 2,4,6-trimethylphenyl group; and G represents a hydrogen atom, an acetyl group, a trifluoroacetyl group, a propionyl group, butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
9) The pyridazinone compounds represented by the general formulas (I¹) to (I³⁰), wherein Ar represents a 2-ethyl-4,6-dimethylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
10) The pyridazinone compounds represented by the general formulas (I¹) to)(I³⁰), wherein Ar represents a 2,6-diethyl-4-methylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
11) The pyridazinone compounds represented by the general formulas (I¹) to (I³⁰), wherein Ar represents a 2,4,6-triethylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
12) The pyridazinone compounds represented by the general formulas (I¹) to (I³⁰), wherein Ar represents a 2,4-diethylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.
13) The pyridazinone compounds represented by the general formulas (I¹) to (I³⁰), wherein Ar represents a 2,4-diethyl-6-methylphenyl group; and G represents a hydrogen atom, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a phenoxycarbonyl group, a dimethylaminocarbonyl group, a methanesulfonyl group, a trifluoromethanesulfonyl group, a benzenesulfonyl group or a p-toluenesulfonyl group.

Hereinafter, the present invention will be explained in more detail by Production Examples, Formulation Examples and Test Examples. However, the present invention is not limited thereto.

In Production Examples, room temperature usually represents from 10 to 30° C. ¹H NMR denoted a proton nuclear magnetic resonance spectrum, tetramethylsilane was used as the internal standard, and the chemical shift (6) was represented by ppm.

The symbols used in Production Examples have the following meanings.

CDCl₃: chloroform-d, s: singlet, d: doublet, t: triplet, q-quartet, dt: doublet triplet, dq: doublet quartet, m: multiplet, br.: broad, J: coupling constant, Me: methyl group, Et: ethyl group, Pr: propyl group, i-Pr: isopropyl group, t-Bu: tertiary-butyl group, c-Hex: cyclohexyl group, Ph: phenyl group

### Production Example 1

### 4-(2-Ethylphenyl)-5-hydroxy-2-methyl-3(2H)-pyridazinone (compound I-a-1)

To 3.193 g of 4-(2-ethylphenyl)-5-methoxy-2-methyl-3(2H)-pyridazinone (compound II-1) were added 50 mL of water, 4.657 g of potassium hydroxide (85% content) and 5 mL of 1,4-dioxane, and the mixture was stirred with heating under reflux for 36 hours. After cooling, concentrated hydrochloric acid was added to the reaction mixture to make it acidic, and then 10 mL of water and 100 mL of ethyl acetate were added thereto. Insoluble matters in the reaction mixture were filtered off, and the filtrate was separated. The organic layer was washed with water and then saturated brine. The organic layer was dried over anhydrous magnesium sulfate, and the solvent was distilled off. The resultant solid was washed with an ethyl acetate-hexane mixed solvent (1:2) to obtain 2.050 g of the titled compound as colorless crystals.

The compounds prepared in accordance with Production Example 1 together with the compound I-a-1 are shown in Table 1.

The compound represented by the general formula (I-a):

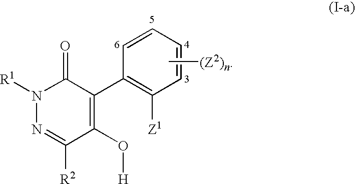

TABLE 1

| | | | | | Melting |
|---|---|---|---|---|---|
| Compounds | R¹ | R² | Z¹ | (Z²)ₙ | point/° C. |
| I-a-1 | Me | H | Et | — | 218-220 |
| I-a-2 | Et | H | Et | — | 190-192 |
| I-a-3 | i-Pr | H | Et | — | 226-227 |
| I-a-4 | MeOCH₂CH₂ | H | Et | — | 137-139 |
| I-a-5 | Me | H | Pr | — | 210-211 |
| I-a-6 | Me | H | Me | 6-Me | 267-271 |
| I-a-7 | Me | H | Et | 6-Me | 239-242 |
| I-a-8 | Me | H | Et | 6-Et | 247-249 |
| I-a-9 | Me | H | Me | 4-Me | 219-220 |
| I-a-10 | Me | H | Me | 4-Me, 6-Me | 272-275 |
| I-a-11 | Et | H | Me | 4-Me, 6-Me | >300 |
| I-a-12 | Me | H | Et | 4-Me, 6-Et | 254-255 |

### Production Example 2

### 4-(2,6-Diethyl-4-methylphenyl)-5-hydroxy-2,6-dimethyl-3(2H)-pyridazinone (compound I-a-14)

A solution of potassium tert-butoxide in 13 mL of tetrahydrofuran (1 mol/L) was stirred at room temperature under a nitrogen atmosphere, to which a solution of 1.9 g of ethyl 2-[2-(2,6-diethyl-4-methylphenylacetyl)-2-methylhydrazono]propanoate (compound VI-2) in 55 mL of toluene was added dropwise over one hour, followed by stirring at room temperature for 30 minutes. Then, the reaction mixture was concentrated under reduced pressure. Ice water (30 mL) was added to the resultant residue, and the mixture was extracted with tert-butylmethyl ether (20 mL×2). Next, 1.6 g of 35% hydrochloric acid was added to the aqueous layer to make it acidic, and the mixture was extracted with ethyl acetate (20 mL×3). The ethyl acetate extracts were combined, washed with saturated brine (20 mL×2), dried over anhydrous magnesium sulfate, and concentrated under reduced pressure. The resultant residue was subjected to silica gel column chromatography (ethyl acetate:hexane=1:3) to obtain 0.76 g of solid. The solid was washed with cold hexane, and air dried to obtain 0.59 g of the titled compound as a white powder.

The compounds prepared in accordance with Production Example 2 together with the compound I-a-14 are shown in Table 2.

The compound represented by the general formula (I-a):

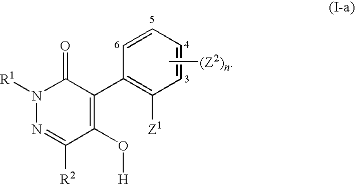

TABLE 2

| | | | | | Melting |
|---|---|---|---|---|---|
| Compounds | R¹ | R² | Z¹ | (Z²)ₙ | point/° C. |
| I-a-13 | Me | Me | Me | 4-Me, 6-Me | 199-201 |
| I-a-14 | Me | Me | Et | 4-Me, 6-Et | 205-206 |
| I-a-15 | Me | Me | Et | — | 171-172 |
| I-a-16 | Me | Me | Et | 4-Me | 187-188 |
| I-a-17 | Me | Me | Et | 4-Et, 6-Et | 188-190 |
| I-a-18 | Me | Me | Et | 4-Me, 6-Me | 176-177 |
| I-a-19 | Me | Et | Et | 4-Me, 6-Et | 194-195 |
| I-a-20 | Me | Et | Et | 4-Me | 148-149 |
| I-a-21 | Me | Et | Et | 4-Me, 6-Me | 188-189 |
| I-a-22 | Me | Et | Me | 4-Me, 6-Me | 210-211 |
| I-a-23 | Me | i-Pr | Et | 4-Me, 6-Et | 208-210 |
| I-a-24 | Me | Pr | Et | 4-Me, 6-Et | 175-176 |
| I-a-25 | Me | Et | Et | 4-Me, 6-Et | 170-171 |
| I-a-26 | Me | Pr | Et | 4-Me, 6-Et | 174-175 |
| I-a-27 | Me | Me | Et | 4-Et | 178-180 |
| I-a-28 | Me | Et | Et | 4-Et | 163-164 |
| I-a-29 | Me | Me | Et | 4-Et, 6-Me | 168-169 |
| I-a-30 | Me | Me | Et | 6-Et | 187-188 |

### Production Example 3

### 5-Benzoyloxy-4-(2-ethylphenyl)-2-methyl-3(2H)-pyridazinone (compound I-b-1)

To 0.326 g of the compound I-a-1 prepared in Production Example 1 were added 12 mL of tetrahydrofuran and 0.40 mL of triethylamine. The mixture was ice-cooled, and then 0.25 mL of benzoyl chloride was added thereto. The mixture was stirred with ice-cooling for 10 minutes, followed by stirring at room temperature for 3 hours. To the reaction mixture was added with 30 mL of water, and the mixture was extracted twice with 30 mL of ethyl acetate. The extracts were combined, washed with saturated brine, and dried over anhydrous magnesium sulfate. The solvent was distilled off. The residue was subjected to silica gel column chromatography (ethyl acetate:hexane=1:2→2:1) to obtain 0.463 g of the titled compound as colorless oil.

The compounds prepared in accordance with Production Example 3 together with the compound I-b-1 are shown in Table 3.

The compound represented by the general formula (I-b):

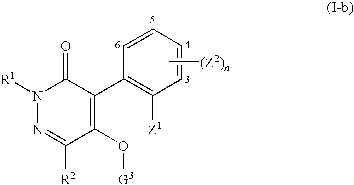

TABLE 3

| | | | | | | Melting |
|---|---|---|---|---|---|---|
| No. | R¹ | R² | Z¹ | (Z²)ₙ | G³ | point/° C. |
| I-b-1 | Me | H | Et | — | COPh | * |
| I-b-2 | Me | H | Et | — | COMe | 69-70 |
| I-b-3 | Me | H | Et | — | COEt | * |
| I-b-4 | Me | H | Et | — | COi-Pr | 77-79 |
| I-b-5 | Me | H | Et | — | COt-Bu | 56-59 |
| I-b-6 | Me | H | Et | — | COc-Hex | * |
| I-b-7 | Me | H | Et | — | CO₂Me | 81-82 |
| I-b-8 | Me | H | Et | — | CONMe₂ | * |
| I-b-9 | Me | H | Et | — | SO₂Me | * |
| I-b-10 | Me | H | Pr | — | COMe | 78-79 |
| I-b-11 | Me | H | Me | 4-Me, 6-Me | COt-Bu | 93-96 |
| I-b-12 | Me | H | Et | 4-Me, 6-Et | COMe | 99-101 |
| I-b-13 | Me | Me | Me | 4-Me, 6-Me | COMe | 130-131 |
| I-b-14 | Me | Me | Et | 4-Me, 6-Et | COMe | 133-134 |
| I-b-15 | Me | Me | Et | 4-Me, 6-Et | COt-Bu | 105-106 |
| I-b-16 | Me | Me | Et | — | COMe | 148-149 |
| I-b-17 | Me | Me | Et | — | COt-Bu | 89 |
| I-b-18 | Me | Me | Et | 4-Me, 6-Et | CO₂Et | 73-74 |
| I-b-19 | Me | Me | Et | 4-Me, 6-Et | COPh | 145-146 |
| I-b-20 | Me | Me | Et | 4-Me | COMe | 142-143 |
| I-b-21 | Me | Me | Et | 4-Et, 6-Et | COMe | 103-104 |
| I-b-22 | Me | Me | Et | 4-Me, 6-Me | COMe | 106-107 |
| I-b-23 | Me | Me | Et | 4-Me, 6-Et | COEt | 103-104 |
| I-b-24 | Me | Me | Et | 4-Me, 6-Et | COi-Pr | 102-103 |
| I-b-25 | Me | Me | Et | 4-Me, 6-Et | CO₂Me | 95-96 |
| I-b-26 | Me | Me | Et | 4-Me, 6-Et | CO₂Ph | 105 |
| I-b-27 | Me | Me | Et | 4-Me, 6-Et | SO₂Me | 153-154 |
| I-b-28 | Me | Me | Et | 4-Me, 6-Et | SO₂CF₃ | 63-67 |
| I-b-29 | Me | Et | Et | 4-Me, 6-Et | COMe | 133-134 |
| I-b-30 | Me | Pr | Et | 4-Me, 6-Et | COMe | 161-162 |
| I-b-31 | Me | i-Pr | Et | 4-Me, 6-Et | COMe | 159-160 |
| I-b-32 | Me | Et | Et | 4-Me, 6-Et | COMe | 117-118 |
| I-b-33 | Me | Me | Et | 4-Et | COMe | 115-116 |
| I-b-34 | Me | Me | Et | 6-Et | COMe | 127-128 |
| I-b-35 | Me | Me | Et | 4-Me, 6-Me | CO₂Et | 65-67 |

Regarding the compounds with asterisk (*) in the column of boiling point in Table 3, the ¹H NMR data are shown below.

### Compound I-b-1:

¹H NMR (CDCl₃) δ ppm: 1.14 (3H, t, J=7.7 Hz), 2.45-2.62 (2H, m), 3.88 (3H, s), 7.09-7.12 (1H, m), 7.15-7.20 (1H, m), 7.28-7.30 (2H, m), 7.37-7.42 (2H, m), 7.55-7.60 (1H, m), 7.81-7.84 (2H, m), 7.95 (1H, s).

### Compound I-b-3:

¹H NMR (CDCl₃) δ ppm: 0.94 (3H, t, J=7.6 Hz), 1.13 (3H, t, J=7.7 Hz), 2.27 (2H, dq, J=1.4, 7.6 Hz), 2.38-2.56 (2H, m), 3.84 (3H, s), 7.00-7.03 (1H, m), 7.18-7.23 (1H, m), 7.30-7.35 (2H, m), 7.75 (1H, s).

### Compound I-b-6:

¹H NMR (CDCl₃) δ ppm: 1.13 (3H, t, J=7.7 Hz), 1.10-1.22 (5H, m), 1.5-1.7 (5H, m), 2.28 (1H, br.), 2.38-2.55 (2H, m), 3.84 (3H, s), 6.99-7.02 (1H, m), 7.17-7.22 (1H, m), 7.29-7.36 (2H, m), 7.72 (1H, s).

### Compound I-b-8:

¹H NMR (CDCl₃) δ ppm: 1.11 (3H, t, J=7.7 Hz), 2.40-2.57 (2H, m), 2.64 (3H, s), 2.85 (3H, s), 3.83 (3H, s), 7.05-7.08 (1H, m), 7.19-7.24 (1H, m), 7.30-7.36 (2H, m), 7.95 (1H, s).

### Compound I-b-9:

¹H NMR (CDCl₃) δ ppm: 1.18 (3H, t, J=7.6 Hz), 2.43-2.57 (2H, m), 2.58 (3H, s), 3.85 (3H, s), 7.16-7.19 (1H, m), 7.25-7.30 (1H, m), 7.36-7.43 (2H, m), 7.96 (1H, s).

A typical production example of the compound represented by the general formula (II) is shown in Reference Example 1.

### Reference Example 1

### 4-(2-Ethylphenyl)-5-methoxy-2-methyl-3(2H)-pyridazinone (compound II-1)

To a mixture of 2.516 g of 4-chloro-5-methoxy-2-methyl-3(2H)-pyridazinone, 2.575 g of 2-ethylphenylboronic acid and 3.333 g of sodium carbonate were added 30 mL of 1,4-dioxane and 20 mL of water. Further, 2.417 g of tetrabutylammonium bromide and 0.657 g of tetrakis(triphenylphosphine) palladium were added thereto, and the mixture was then stirred with heating under reflux for 17 hours under a nitrogen atmosphere. The reaction mixture was cooled, 50 mL of water was added thereto, and extracted with 100 mL, followed by 30 mL of ethyl acetate. The extracts were combined, washed with saturated brine, and dried over anhydrous magnesium sulfate. The solvent was distilled off. The resultant residue was washed with an ethyl acetate-hexane mixture solvent (1:2) to obtain 3.238 g of the titled compound as yellow crystals.

The compounds represented by the general formula (II) prepared in accordance with Reference Example 1 together with the compound II-1 are shown in Table 4.

The compound represented by the general formula (II):

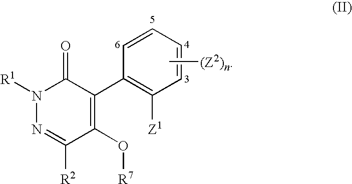

TABLE 4

| | | | | | | Melting |
|---|---|---|---|---|---|---|
| No. | R¹ | R² | Z¹ | (Z²)ₙ | R⁷ | point/° C. |
| II-1 | Me | H | Et | — | Me | 127-130 |
| II-2 | Et | H | Et | — | Me | * |
| II-3 | i-Pr | H | Et | — | Me | 121-123 |
| II-4 | MeOCH₂CH₂ | H | Et | — | Me | * |
| II-5 | Me | H | Pr | — | Me | 86-88 |
| II-6 | Me | H | Me | 6-Me | Me | 187-189 |
| II-7 | Me | H | Et | 6-Me | Me | * |
| II-8 | Me | H | Et | 6-Et | Me | 165-166 |
| II-9 | Me | H | Me | 4-Me | Me | 141-142 |
| II-10 | Me | H | Me | 4-Me, 6-Me | Me | 186-192 |
| II-11 | Et | H | Me | 4-Me, 6-Me | Me | 100-102 |
| II-12 | Me | H | Et | 4-Me, 6-Et | Me | 147-149 |

Regarding the compounds with asterisk (*) in the column of boiling point in Table 4, the ¹H NMR data are shown below.

### Compound II-2:

¹H NMR (CDCl₃) δ ppm: 1.12 (3H, t, J=7.7 Hz), 1.39 (3H, t, J=7.3 Hz), 2.40-2.53 (2H, m), 3.81 (3H, s), 4.19-4.30 (2H, m), 7.10 (1H, d, J=7.6 Hz), 7.21-7.26 (1H, m), 7.30-7.33 (2H, m), 7.88 (1H, s).

### Compound II-4:

¹H NMR (CDCl₃) δ ppm: 1.12 (3H, t, J=7.7 Hz), 2.38-2.52 (2H, m), 3.38 (3H, s), 3.82 (3H, s), 3.77-3.84 (2H, m), 4.40 (2H, t, J=5.6 Hz), 7.11 (1H, d, J=7.6 Hz), 7.21-7.26 (1H, m), 7.30-7.34 (2H, m), 7.90 (1H, s).

### Compound II-7:

¹H NMR (CDCl₃) δ ppm: 1.08 (3H, t, J=7.7 Hz), 2.07 (3H, s), 2.30-2.45 (2H, m), 3.81 (3H, s), 3.82 (3H, s), 7.10 (1H, d, J=7.6 Hz), 7.13 (1H, d, J=7.6 Hz), 7.24 (1H, t, J=7.6 Hz), 7.85 (1H, s).

A typical production example of the compound represented by the general formula (V-a) is shown by Reference Example 2.

### Reference Example 2

### 2-Propylphenylboronic acid

In a reaction vessel, 15.5 mL of butyl lithium (1.6 mol/L in hexane solution) was placed, and cooled in a dry ice-acetone bath. A solution of 4.412 g of 2-propylbromobenzene in 45 mL of tetrahydrofuran was added dropwise into the reaction vessel at −70° C. under a nitrogen atmosphere over 85 minutes. The resultant mixture was stirred at −70° C. for 30 minutes, and to the mixture was added dropwise 3.75 mL of trimethyl borate at −70° C. over 15 minutes. The mixture was stirred at −70° C. for one hour, taken out of the dry ice-acetone bath, and stirred at room temperature for 18 hours. To the reaction mixture was added dropwise 33 mL of 2N hydrochloric acid over 10 minutes, and the mixture was then stirred for 4 hours at room temperature. To the resultant mixture was added 20 mL of water, and the mixture was extracted with 70 mL of ethyl acetate. The extract was washed with saturated brine, and dried over anhydrous magnesium sulfate. The solvent was distilled off. The residue was subjected to silica gel column chromatography (ethyl acetate:hexane=1:2→2:1) to obtain 1.641 g of the titled compound as colorless crystals.

¹H NMR (CDCl₃) δ ppm: 1.01 (3H, t, J=7.4 Hz), 1.69-1.79 (2H, m), 3.15-3.20 (2H, m), 4.0-6.0 (2H, br.), 7.28-7.33 (2H, m), 7.47 (1H, dt, J=1.5, 7.6 Hz), 8.20-8.23 (1H, m).

The compounds shown by the following general formula (V-a) were prepared in accordance with Reference Example 2.

2-Ethyl-6-methylphenylboronic acid: mp 90 to 91° C.

¹H NMR (CDCl₃) δ ppm: 1.22 (3H, t, J=7.6 Hz), 2.35 (3H, s), 2.64 (2H, q, J=7.6 Hz), 4.0-5.5 (2H, br.), 6.98 (1H, d, J=7.7 Hz), 7.01 (1H, d, J=7.7 Hz), 7.18 (1H, t, J=7.7 Hz).

2,6-Diethyl-4-methylphenylboronic acid: mp 111 to 113° C.

¹H NMR (CDCl₃) δ ppm: 1.23 (6H, t, J=7.7 Hz), 2.31 (3H, s), 2.63 (4H, q, J=7.7 Hz), 4.0-5.0 (2H, br.), 6.88 (2H, s).

A typical production example of the compound represented by the general formula (VI) is shown by Reference Example 3.

### Reference Example 3

### 2-[2-(2,6-Diethyl-4-methylphenylacetyl)-2-methylhydrazono]ethyl propanoate (compound VI-2)

Potassium carbonate (1.5 g) was added to a solution of 2.0 g of ethyl 2-(methylhydrazono)propanoate in 35 mL of acetonitrile. The mixture was stirred with ice-cooling, to the mixture was added dropwise a solution of 2.6 g of 2,6-diethyl-4-methylphenylacetyl chloride in 10 mL of acetonitrile over 20 minutes, and the mixture was further stirred for 3.5 hours at room temperature. The reaction mixture was concentrated under reduced pressure. To the resultant residue was added 20 mL of ice water and the mixture was extracted with ethyl acetate (20 mL×3). The extracts were combined, washed with saturated brine (20 mL×2), dried over anhydrous magnesium sulfate, and concentrated under reduced pressure. The resultant residue was subjected to basic alumina column chromatography (ethyl acetate:hexane=1:3) to obtain 1.9 g of the titled compound as white crystals.

The compounds represented by the general formula (VI) prepared in accordance with Reference Example 3 together with the compound VI-2 are shown in Table 5.

The compound represented by the general formula (VI):

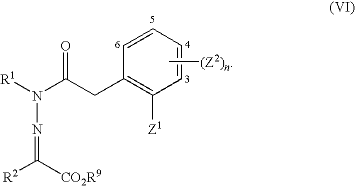

TABLE 5

| | | | | | | Melting |
|---|---|---|---|---|---|---|
| No. | R¹ | R² | Z¹ | (Z²)ₙ | R⁷ | point/° C. |
| VI-1 | Me | Me | Me | 4-Me, 6-Me | Et | 90-91 |
| VI-2 | Me | Me | Et | 4-Me, 6-Et | Et | 73-76 |
| VI-3 | Me | Me | Et | — | Et | * |
| VI-4 | Me | Me | Et | 4-Me | Et | * |
| VI-5 | Me | Me | Et | 4-Et, 6-Et | Et | 63-66 |
| VI-6 | Me | Me | Et | 4-Me, 6-Me | Et | * |
| VI-7 | Me | Et | Et | 4-Me, 6-Et | Et | * |
| VI-8 | Me | Et | Et | 4-Me | Et | * |
| VI-9 | Me | Et | Et | 4-Me, 6-Me | Et | * |
| VI-10 | Me | Et | Me | 4-Me, 6-Me | Et | * |
| VI-11 | Me | i-Pr | Et | 4-Me, 6-Et | Et | * |
| VI-12 | Me | Pr | Et | 4-Me, 6-Et | Et | * |
| VI-13 | Me | Et | Et | 4-Me, 6-Et | Et | * |
| VI-14 | Me | Pr | Et | 4-Me, 6-Et | Et | * |
| VI-15 | Me | Me | Et | 4-Et | Et | * |
| VI-16 | Me | Et | Et | 4-Et | Et | * |
| VI-17 | Me | Me | Et | 4-Et, 6-Me | Et | * |
| VI-18 | Me | Me | Et | 6-Et | Et | * |

Regarding the compounds with asterisk (*) in the column of boiling point in Table 5, the ¹H NMR data are shown below.

### Compound VI-3:

¹H NMR (CDCl₃) δ ppm: 1.19 (3H, t, J=7.6 Hz), 1.37 (3H, t, J=7.2 Hz), 2.20 (3H, br. s), 2.67 (2H, q, J=7.7 Hz), 3.37 (3H, br. s), 4.03 (2H, br. s), 4.33 (2H, q, J=7.0 Hz), 7.06-7.30 (4H, m).

### Compound VI-4:

¹H NMR (CDCl₃) δ ppm: 1.18 (3H, t, J=7.6 Hz), 1.37 (3H, t, J=7.2 Hz), 2.20 (3H, br. s), 2.30 (3H, s), 2.63 (2H, q, J=7.7 Hz), 3.36 (3H, br. s), 3.99 (2H, br. s), 4.33 (2H, q, J=7.1 Hz), 6.93 (1H, br. d, J=7.1 Hz), 7.00 (1H, br. s), 7.12 (1H, br. d, J=7.8 Hz).

### Compound VI-6:

¹H NMR (CDCl₃) δ ppm: 1.16 (3H, t, J=7.7 Hz), 1.36 (3H, t, J=7.2 Hz), 2.22 (3H, s), 2.27 (3H, s), 2.30 (3H, br. s), 2.56 (2H, q, J=7.7 Hz), 3.39 (3H, br. s), 4.02 (2H, br. s), 4.32 (2H, q, J=7.1 Hz), 6.86 (2H, br. s).

Compound VI-7 (mixture of E/Z isomers):

¹H NMR (CDCl₃) δ ppm: 1.13-1.25 (9H, m), 1.31-1.41 (3H, m), 2.29 (3H, s), 2.50-2.81 (6H, m), 3.23, 3.43 (3H, each br. s), 4.05 (2H, br. s), 4.27-4.39 (2H, m), 6.89 (2H, s).

Compound VI-8 (mixture of E/Z isomers):

¹H NMR (CDCl₃) δ ppm: 1.06-1.22 (6H, m), 1.31-1.40 (3H, m), 2.30, 2.31 (3H, each s), 2.50-2.70 (4H, m), 3.22, 3.38 (3H, each s), 4.00 (2H, br. s), 4.27-4.37 (2H, m), 6.90-6.98 (1H, m), 6.98-7.02 (1H, m), 7.02-7.14 (1H, m).

Compound VI-9 (mixture of E/Z isomers):

¹H NMR (CDCl₃) δ ppm: 1.12-1.25 (6H, m), 1.31-1.41 (3H, m), 2.22 (3H, s), 2.27 (3H, s), 2.50-2.81 (4H, m), 3.23, 3.43 (3H, each br. s), 4.02 (2H, br. s), 4.26-4.37 (2H, m), 6.87 (2H, br. s).

Compound VI-10 (mixture of E/Z isomers):

¹H NMR (CDCl₃) δ ppm: 1.16-1.24 (3H, m), 1.32-1.40 (3H, m), 2.22 (6H, s), 2.25 (3H, s), 2.55-2.80 (2H, m), 3.23, 3.43 (3H, each br. s), 4.00 (2H, br. s), 4.27-4.38 (2H, m), 6.85 (2H, s).

### Compound VI-11:

¹H NMR (CDCl₃) δ ppm: 1.18 (6H, t, J=7.6 Hz), 1.24 (6H, d, J=6.8 Hz), 1.37 (3H, t, J=7.1 Hz), 2.29 (3H, s), 2.55 (4H, q, J=7.6 Hz), 2.85 (1H, septet, J=6.8 Hz), 3.22 (3H, s), 4.04 (2H, s), 4.34 (2H, q, J=7.2 Hz), 6.88 (2H, s).

Compound VI-12 (mixture of E/Z isomers):

¹H NMR (CDCl₃) δ ppm: 1.01 (3H, t, J=7.4 Hz), 1.17 (6H, t, J=7.6 Hz), 1.31-1.40 (3H, m), 1.57-1.74 (2H, m), 2.30 (3H, s), 2.50-2.76 (6H, m), 3.22, 3.42 (3H, each s), 4.03, 4.05 (2H, each br. s), 4.26-4.36 (2H, m), 6.89 (2H, s).

Compound VI-13 (mixture of E/Z isomers):

¹H NMR (CDCl₃) δ ppm: 1.13-1.28 (12H, m), 1.30-1.40 (3H, m), 2.50-2.80 (8H, m), 3.23, 3.44 (3H, each s), 4.06 (2H, br. s), 4.28-4.39 (2H, m), 6.91 (2H, s).

Compound VI-14 (mixture of E/Z isomers):

¹H NMR (CDCl₃) δ ppm: 1.01 (3H, br. t, J=7.2 Hz), 1.13-1.26 (9H, m), 1.30-1.40 (3H, m), 1.56-1.73 (2H, m), 2.50-2.76 (8H, m), 3.22, 3.42 (3H, each s), 4.03, 4.06 (2H, each br. s), 4.26-4.37 (2H, m), 6.91 (2H, s).

### Compound VI-15:

¹H NMR (CDCl₃) δ ppm: 1.15-1.25 (6H, m), 1.37 (3H, t, J=7.2 Hz), 2.20 (3H, br. s), 2.55-2.70 (4H, m), 3.36 (3H, br. s), 3.99 (2H, br. s), 4.33 (2H, q, J=7.1 Hz), 6.96 (1H, br. d, J=7.3 Hz), 7.02 (1H, br. s), 7.15 (1H, br. d, J=7.8 Hz).

Compound VI-16 (mixture of E/Z isomers):

¹H NMR (CDCl₃) δ ppm: 1.05-1.25 (9H, m), 1.32-1.40 (3H, m), 2.50-2.69 (6H, m), 3.22, 3.38 (3H, each s), 4.00 (2H, br. s), 4.26-4.36 (2H, m), 6.93-7.00 (1H, m), 7.00-7.04 (1H, m), 7.06-7.18 (1H, m).

### Compound VI-17:

¹H NMR (CDCl₃) δ ppm: 1.17 (3H, t, J=7.6 Hz), 1.22 (3H, t, J=7.6 Hz), 1.36 (3H, t, J=7.1 Hz), 2.24 (3H, s), 2.30 (3H, br. s), 2.58 (4H, q, J=7.6 Hz), 3.40 (3H, br. s), 4.03 (2H, br. s), 4.32 (2H, q, J=7.2 Hz), 6.89 (2H, s).

### Compound VI-18:

¹H NMR (CDCl₃) δ ppm: 1.19 (6H, t, J=7.6 Hz), 1.36 (3H, t, J=7.2 Hz), 2.32 (3H, br. s), 2.60 (4H, q, J=7.7 Hz), 3.40 (3H, br. s), 4.09 (2H, br. s), 4.33 (2H, q, J=7.2 Hz), 7.07 (2H, d, J=7.6 Hz), 7.18 (1H, t, J=7.6 Hz).

Hereinafter, Formulation Examples will be shown. Formulation Example 1

Liquid formulation

| | |
|---|---|
| Compound I-a-1 | 10% by weight |
| Glyphosate potassium salt | 10% by weight |
| S-Metolachlor | 5% by weight |
| Polyoxyethylene alkyl ether | 5% by weight |
| N-Methyl-2-pyrrolidone | 70% by weight |

The above ingredients are mixed to obtain a liquid formulation. The liquid formulation thus obtained is appropriately diluted with water before use.

According to the same manner, respective liquid formulations of the compounds I-a-2 to I-a-30 and I-b-1 to I-b-35 are obtained except that these compounds are used instead of the compound I-a-1.

### Formulation Example 2

Wettable powder

| | |
|---|---|
| Compound I-b-2 | 20% by weight |
| Glyphosate potassium salt | 10% by weight |
| S-Metolachlor | 10% by weight |
| Lignin sodium sulfonate | 5% by weight |
| Polyoxyethylene alkyl ether | 5% by weight |
| White carbon | 5% by weight |
| Clay | 45% by weight |

The above ingredients are mixed and the mixture is ground to obtain a wettable powder. The wettable powder thus obtained is appropriately diluted with water before use.

According to the same manner, respective wettable powders of the compounds I-a-1 to I-a-30, I-b-1 and I-b-3 to I-b-35 are obtained.

### Formulation Example 3

Liquid formulation

| | |
|---|---|
| Compound I-b-20 | 5% by weight |
| Glyphosate potassium salt | 10% by weight |
| Acetochlor | 5% by weight |
| Polyoxyethylene alkyl ether | 5% by weight |
| N-Methyl-2-pyrrolidone | 75% by weight |

The above ingredients are mixed to obtain a liquid formulation. The liquid formulation is appropriately diluted with water before use.

According to the same manner, respective liquid formulations of the compounds I-a-1 to I-a-30, I-b-1 to I-b-19 and I-b-21 to I-b-35 are obtained.

### Formulation Example 4

Wettable powder

| | |
|---|---|
| Compound I-a-2 | 2% by weight |
| Glyphosate potassium salt | 20% by weight |
| Acetochlor | 10% by weight |
| Lignin sodium sulfonate | 5% by weight |
| Polyoxyethylene alkyl ether | 5% by weight |
| White carbon | 5% by weight |
| Clay | 53% by weight |

The above ingredients are mixed and the mixture is ground to obtain a wettable powder. The wettable powder thus obtained is appropriately diluted with water before use.

According to the same manner, respective wettable powders of the compounds I-a-1, I-a-3 to I-a-30 and I-b-1 to I-b-35 are obtained.

### Formulation Example 5

Liquid formulation

| | |
|---|---|
| Compound I-b-3 | 2% by weight |
| Glyphosate potassium salt | 10% by weight |
| Atrazine | 10% by weight |
| Polyoxyethylene alkyl ether | 5% by weight |
| N-Methyl-2-pyrrolidone | 73% by weight |

The above ingredients are mixed to obtain a liquid formulation. The liquid formulation thus obtained is appropriately diluted with water before use.

According to the same manner, respective liquid formulations of the compounds I-a-1 to I-a-30, I-b-1 to I-b-2 and I-b-4 to I-b-35 are obtained.

### Formulation Example 6

Wettable powder

| | |
|---|---|
| Compound I-a-21 | 5% by weight |
| Glyphoste potassium salt | 20% by weight |
| Atrazine | 10% by weight |
| Lignin sodium sulfonate | 5% by weight |
| Polyoxyethylene alkyl ether | 5% by weight |
| White carbon | 5% by weight |
| Clay | 50% by weight |

The above ingredients are mixed and the mixture is ground to obtain a wettable powder. The wettable powder thus obtained is appropriately diluted with water before use.

According to the same manner, respective wettable powders of the compounds I-a-1 to I-a-20, I-a-22 to I-a-30 and I-b-1 to I-b-35 are obtained.

### Formulation Example 7

Liquid formulation

| | |
|---|---|
| Compound I-a-14 | 5% by weight |
| Glyphosate potassium salt | 10% by weight |
| 2,4-D amine salt | 10% by weight |
| Polyoxyethylene alkyl ether | 5% by weight |
| N-Methyl-2-pyrrolidone | 70% by weight |

The above ingredients are mixed to obtain a liquid formulation. The liquid formulation thus obtained is appropriately diluted with water before use.

According to the same manner, respective liquid formulations of the compounds I-a-1 to I-a-13, I-a-15 to I-a-30 and I-b-1 to I-b-35 are obtained.

### Formulation Example 8

Wettable powder

| | |
|---|---|
| Compound I-b-14 | 2% by weight |
| Glyphosate potassium salt | 10% by weight |
| 2,4-D amine salt | 5% by weight |
| Lignin sodium sulfonate | 5% by weight |
| Polyoxyethylene alkyl ether | 5% by weight |
| White carbon | 5% by weight |
| Clay | 68% by weight |

The above ingredients are mixed and the mixture is ground to obtain a wettable powder. The wettable powder thus obtained is appropriately diluted with water before use.

According to the same manner, respective wettable powders of the compounds I-a-1 to I-a-30, I-b-1 to I-b-13 and I-b-15 to I-b-35 are obtained.

### Formulation Example 9

Liquid formulation

| | |
|---|---|
| Compound I-b-21 | 5% by weight |
| Glyphosate potassium salt | 10% by weight |
| Dicamba | 5% by weight |
| Polyoxyethylene alkyl ether | 5% by weight |
| N-Methyl-2-pyrrolidone | 75% by weight |

The above ingredients are mixed to obtain a liquid formulation. The liquid formulation thus obtained is appropriately diluted with water before use.

According to the same manner, respective liquid formulations of the compounds I-a-1 to I-a-30, I-b-1 to I-b-20 and I-b-22 to I-b-35 are obtained.

### Formulation Example 10

Wettable powder

| | |
|---|---|
| Compound I-a-17 | 5% by weight |
| Glyphosate potassium salt | 5% by weight |
| Dicamba | 5% by weight |
| Lignin sodium sulfonate | 5% by weight |
| Polyoxyethylene alkyl ether | 5% by weight |
| White carbon | 5% by weight |
| Clay | 70% by weight |

The above ingredients are mixed and the mixture is ground obtain a wettable powder. The wettable powder thus obtained is appropriately diluted with water before use.

According to the same manner, respective wettable powders of the compounds I-a-1 to I-a-16, I-a-18 to I-a-30 and I-b-1 to I-b-35 are obtained.

### Formulation Example 11

Five parts of the present compound (I-b-12), 5 parts of glyphosate potassium salt, 5 parts of S-metolachlor and 10 parts of any one of the compounds selected from the following group B are added to a mixture of 5 parts of polyoxyethylene alkyl ether and 70 parts of N-methyl-2-pyrollidone, followed by thoroughly mixing with stirring to obtain a liquid formulation.

According to the same manner, respective liquid formulations of the compounds I-a-1 to I-a-30, I-b-1 to I-b-11 and I-b-13 to I-b-35 are obtained.

### Group B:

herbicidal phenoxyfatty acid compounds (MCP, MOPE, phenothiol, mecoprop, fluoroxypyr, triclopyr, clomeprop, naproanilide),

herbicidal benzoate compounds (2,3,6-TBA, clopyrald, picloram, aminopyralid, quinclorac, quinmerac),

herbicidal urea compounds (diuron, linuron, chlortoluron, isoproturon, fluometuron, isouron, tebuthiuron, methabenzthiazuron, cumyluron, daimuron, methyl-daimuron),

herbicidal triazine compounds (ametoryn, cyanazine, simazine, propazine, simetryn, dimethametryn, prometryn, metribuzin, triaziflam),

herbicidal bipyridinium compounds (paraquat, diquat),

herbicidal hydroxybenzonitrile compounds (bromoxynil, ioxynil),

herbicidal dinitroaniline compounds (pendimethalin, prodiamine, trifluralin),

herbicidal organophosphorous compounds (amiprofos-methyl, butamifos, bensulide, piperophos, anilofos, glufosinate, bialaphos),

herbicidal carbamate compounds (di-allate, tri-allate, EPTC, butylate, benthiocarb, esprocarb, molinate, dimepiperate, swep, chlorpropham, phenmedipham, phenisopham, pyributicarb, asulam),

herbicidal acid amide compounds (propanil, propyzamide, bromobutide, etobenzanid),

herbicidal chloroacetanilide compounds (alachlor, butachlor, dimethenamid, propachlor, metazachlor, pretilachlor, thenylchlor, pethoxamid),

herbicidal diphenylether compounds (acifluorfen-sodium, bifenox, oxyfluorfen, lactofen, fomesafen, chlomethoxynil, aclonifen),

herbicidal cyclicimide compounds (oxadiazon, cinidon-ethyl, carfentrazone-ethyl, surfentrazone, flumiclorac-pentyl, pyraflufen-ethyl, oxadiargyl, pentoxazone; fluthiacet-methyl, butafenacil, benzfendizone),

herbicidal pyrazole compounds (benzofenap, pyrazolate, pyrazoxyfen, topramezone, pyrasulfotole),

herbicidal triketone compounds (isoxaflutole, benzobicyclon, sulcotrione, mesotrione, tembotrione, tefuryltrione),

herbicidal aryloxyphenoxypropionate compounds (cyhalofop-butyl, diclofop-methyl, fenoxaprop-ethyl, fluazifop-butyl, haloxyfop-methyl, quizalofop-ethyl, metamifop),

herbicidal trioneoime compounds (alloxydim-sodium, sethoxydim, butroxydim, clethodim, cloproxydim, cycloxydim, tepraloxydim, tralkoxydim, profoxydim),

herbicidal sulfonylurea compounds (chlorsulfuron, sulfometuron-methyl, metsulfuron-methyl, tribenuron-methyl, triasulfuron, bensulfuron-methyl, thifensulfuron-methyl, pyrazosulfuron-ethyl, primisulfuron-methyl, nicosulfuron, amidosulfuron, cinosulfuron, imazosulfuron, rimsulfuron, halosulfuron-methyl, prosulfuron, ethametsulfuron-methyl, triflusulfuron-methyl, flazasulfuron, cyclosulfamuron, flupyrsulfuron, sulfosulfuron, azimsulfuron, ethoxysulfuron, oxasulfuron, iodosulfuron-methyl-sodium, foramsulfuron, mesosulfuron-methyl, trifloxysulfuron, tritosulfuron, orthosulfamuron, flucetosulfuron),

herbicidal imidazolinone compounds (imazamethabenz-methyl, imazamethapyr, imazamox, imazapyr, imazaquin), imazethapyr),

herbicidal sulfoneamide compounds (flumetsulam, metosulam, diclosulam, florasulam, penoxsulam, pyroxsulam),

herbicidal pyrimidinyloxybenzoate compounds (pyrithiobac-sodium, bispyribac-sodium, pyriminobac-methyl, pyribenzoxim, pyriftalid, pyrimisulfan),

Other herbicidal compounds (bentazon, bromacil, terbacil, chlorthiamid, isoxaben, dinoseb, amitrole, cinmethylin, tridiphane, dalapon, diflufenzopyr-sodium, dithiopyr, thiazopyr, flucarbazone-sodium, propoxycarbazone-sodium, mefenacet, flufenacet, fentrazamide, cafenstrole, indanofan, oxaziclomefone, benfuresate, ACN, pyridate, chloridazon, norflurazon, flurtamone, diflufenican, picolinafen, beflubutamid, clomazone, amicarbazone, pyraclonil, pyroxasulfone, thiencarbazone-methyl), and

safeners (furilazole, dichlormid, benoxacor, allidochlor, isoxadifen-ethyl, fenclorim, cyprosulfamide, cyometrinil, oxabetrinil, fluxofenim, flurazole, 1,8-naphthalic anhydride).

### Formulation Example 12

Five parts of the present compound (I-a-14), 10 parts of glyphosate potassium salt, 5 parts of S-metolachlor and 5 parts of any one of the compounds selected from the above group B are mixed with 5 parts of lignin sodium sulfonate, 5 parts of polyoxyethylene alkyl ether, 5 parts of white carbon and 60 parts of clay, followed by grinding to obtain a wettable powder. The wettable powder thus obtained is appropriately diluted with water before use.

According to the same manner, respective wettable powders of the compounds I-a-1 to I-a-13, I-a-15 to I-a-30 and I-b-1 to I-b-35 are obtained.

### Formulation Example 13

Two parts of the present compound (I-a-16), 15 parts of glyphosate potassium salt, 5 parts of acetochlor and 5 parts of any one of the compounds selected from the above group B are added to a mixture of 5 parts of polyoxyethylene alkyl ether and 68 parts of N-methyl-2-pyrollidone, followed by thoroughly mixed with stirring to obtain a liquid formulation.

According to the same manner, respective liquid formulations of the compounds I-a-1 to I-a-15, I-a-17 to I-a-30 and I-b-1 to I-b-35 are obtained.

### Formulation Example 14

Two parts of the present compound (I-b-19), 5 parts of glyphosate potassium salt, 5 parts of acetochlor and 5 parts of any one of the compounds selected from the above group B are mixed with 5 parts of lignin sodium sulfonate, 5 parts of polyoxyethylene alkyl ether, 5 parts of white carbon and 68 parts of clay, followed by grinding to obtain a wettable powder. The wettable powder thus obtained is appropriately diluted with water before use.

According to the same manner, respective wettable powders of the compounds I-a-1 to I-a-30, I-b-1 to I-b-18 and I-b-20 to I-b-35 are obtained.

### Formulation Example 15

Two parts of the present compound (I-a-30), 10 parts of glyphosate potassium salt, 10 parts of atrazine and 5 parts of any one of the compounds selected from the above group B are added to a mixture of 5 parts of polyoxyethylene alkyl ether and 68 parts of N-methyl-2-pyrollidone, followed by thoroughly mixing with stirring to obtain a liquid formulation.

According to the same manner, respective liquid formulations of the compounds I-a-1 to I-a-29 and I-b-1 to I-b-35 are obtained.

### Formulation Example 16

Five parts of the present compound (I-b-18), 5 parts of glyphosate potassium salt, 5 parts of atrazine and 10 parts of any one of the compounds selected from the above group B are mixed with 5 parts of lignin sodium sulfonate, 5 parts of polyoxyethylene alkyl ether, 5 parts of white carbon and 60 parts of clay, followed by grinding to obtain a wettable powder. The wettable powder thus obtained is appropriately diluted with water before use.

According to the same manner, respective wettable powders of the compounds I-a-1 to I-a-30, I-b-1 to I-b-17 and I-b-19 to I-b-35 are obtained.

### Formulation Example 17

Five parts of the present compound (I-b-3), 15 parts of glyphosate potassium salt, 5 parts of a 2,4-D amine salt and 5 parts of any one of the compounds selected from the above group B are added to a mixture of 5 parts of polyoxyethylene alkyl ether and 65 parts of N-methyl-2-pyrollidone, followed by thoroughly mixing with stirring to obtain a liquid formulation.

According to the same manner, respective liquid formulations of the compounds I-a-1 to I-a-30, I-b-1, I-b-2 and I-b-4 to I-b-35 are obtained.

### Formulation Example 18

Five parts of the present compound (I-a-12), 5 parts of glyphosate potassium salt, 5 parts of a 2,4-D amine salt and 5 parts of any one of the compounds selected from the above group B are mixed with 5 parts of lignin sodium sulfonate, 5 parts of polyoxyethylene alkyl ether, 5 parts of white carbon and 65 parts of clay, followed by grinding to obtain a wettable powder. The wettable powder thus obtained is appropriately diluted with water before use.

According to the same manner, respective wettable powders of the compounds I-a-1 to I-a-11, I-a-13 to I-a-30 and I-b-1 to I-b-35 are obtained.

### Formulation Example 19

Ten parts of the present compound (I-a-10), 10 parts of glyphosate potassium salt, 5 parts of dicamba and 5 parts of any one of the compounds selected from the above group B are added to a mixture of 5 parts of polyoxyethylene alkyl ether and 65 parts of N-methyl-2-pyrollidone, followed by thoroughly mixing with stirring to obtain a liquid formulation.

According to the same manner, respective liquid formulations of the compounds I-a-1 to I-a-9, I-a-11 to I-a-30 and I-b-1 to I-b-35 are obtained.

### Formulation Example 20

Two parts of the present compound (I-b-25), 10 parts of glyphosate potassium salt, 10 parts of dicamba and 5 parts of any one of the compounds selected from the above group B are mixed with 5 parts of lignin sodium sulfonate, 5 parts of polyoxyethylene alkyl ether, 5 parts of white carbon and 58 parts of clay, followed by grinding to obtain a wettable powder. The wettable powder thus obtained is appropriately diluted with water before use.

According to the same manner, respective wettable powders of the compounds I-a-1 to I-a-30, I-b-1 to I-b-24 and I-b-26 to I-b-35 are obtained.

Test Examples will be described below.

### Test Example 1

### Post-Emergence Treatment Test

Field soil was filled in a plastic cup (8 cm in diameter and 6.5 cm in depth), 2 kinds of weed seeds, Echinochloa crus-galli and Setaria faberi, or 4 kinds of weed seeds, Echinochloa crus-galli, Setaria faberi, Abutilon theophrasti and Stellaria media, were sown thereon, and the seeds were covered with soil about 0.5 cm of thickness and then cultured in a greenhouse for a predetermined period (until the weeds grew at 1^{st} to 2^{nd} leaf stage). A diluent of the formulation containing the compound I-a-14, glyphosate potassium salt (hereinafter, sometimes, referred to as the compound B) and one of herbicides selected from the above group A [i.e., S-metolachlor (hereinafter, sometimes, referred to as the compound C), acetochlor (hereinafter, sometimes, referred to as the compound D), atrazine (hereinafter, sometimes, referred to as the compound E), dicamba (hereinafter, sometimes, referred to as the compound F) and 2,4-D amine salt (hereinafter, sometimes, referred to as the compound G)] was sprayed over the entire plants uniformly in a predetermined treatment amount. The compound I-a-14 and atrazine were prepared by dissolving a predetermined amount of respective bulks in a dimethylformamide solution of Tween 20 (polyoxyethylene sorbitan fatty acid ester; manufactured by MP Biomedicals Ink Corp., 2%), followed by diluting the solution with deionized water. Glyphosate potassium salt was prepared by diluting Roundup Original Max (registered trademark) (manufactured by Monsanto) with deionized water. S-Metolachlor was prepared by diluting Dual II Magnum (registered trademark) (manufactured by Syngenta Crop Protection), acetochlor was prepared by diluting Harness (registered trademark) (manufactured by Monsanto), dicamba was prepared by diluting Banvel D (registered trademark) (manufactured by DIC Corp.), and 2,4-D amine salt was prepared by diluting Nissan (registered trademark) Amine Salt (manufactured by Nissan Chemical Industries, Ltd.) with deionized water, respectively. The plants treated with the formulation were cultured in the greenhouse. 21 days after the treatment, the herbicidal effect was evaluated according to the criteria shown in Table 6.

The post-emergence treatment test was carried out for the other herbicidal compositions of the present invention according to the same manner except for using the compound I-a-15, I-a-16, I-a-17, I-a-18, I-b-16, I-b-19, I-b-20 or I-b-23 instead of the compound I-a-14. The results are shown in Tables 7 to 11.

TABLE 6

| Index | Herbicidal effect |
|---|---|
| 10 | 100% (complete killing) herbicidal effect |
| 9 | 90-100% herbicidal effect |
| 8 | 80-90% herbicidal effect |
| 7 | 70-80% herbicidal effect |
| 6 | 60-70% herbicidal effect |
| 5 | 50-60% herbicidal effect |
| 4 | 40-50% herbicidal effect |
| 3 | 30-40% herbicidal effect |
| 2 | 20-30% herbicidal effect |
| 1 | 10-20% herbicidal effect |
| 0 | 0 (no effect)-10% herbicidal effect |

TABLE 7

| Herbicidal | | | |
|---|---|---|---|
| composition of | | Post-emergence effect | |
| the present | | Echinochloa | |
| invention | Dosage (g/ha) | crus-galli | Setaria faberi |
| I-a-14 + Compound | 50 + 1000 + 500 | 10 | 10 |
| B + Compound C | | | |
| I-a-15 + Compound | 200 + 100 + 20 | 10 | 10 |
| B + Compound C | | | |
| I-a-16 + Compound | 100 + 10 + 500 | 10 | 10 |
| B + Compound C | | | |
| I-a-17 + Compound | 10 + 1000 + 500 | 10 | 10 |
| B + Compound C | | | |
| I-a-18 + Compound | 10 + 500 + 1000 | 10 | 10 |
| B + Compound C | | | |
| I-b-16 + Compound | 50 + 100 + 1000 | 9 | 10 |
| B + Compound C | | | |
| I-b-19 + Compound | 200 + 500 + 500 | 10 | 10 |
| B + Compound C | | | |
| I-b-20 + Compound | 200 + 20 + 500 | 10 | 10 |
| B + Compound C | | | |
| I-b-23 + Compound | 10 + 100 + 1000 | 9 | 10 |
| B + Compound C | | | |

TABLE 8

| Herbicidal | | | |
|---|---|---|---|
| composition of | | Post-emergence effect | |
| the present | | Echinochloa | |
| invention | Dosage (g/ha) | crus-galli | Setaria faberi |
| I-a-14 + Compound | 10 + 500 + 1000 | 10 | 10 |
| B + Compound D | | | |
| I-a-15 + Compound | 100 + 10 + 500 | 10 | 10 |
| B + Compound D | | | |
| I-a-16 + Compound | 50 + 500 + 1000 | 10 | 10 |
| B + Compound D | | | |
| I-a-17 + Compound | 20 + 1000 + 100 | 10 | 10 |
| B + Compound D | | | |
| I-a-18 + Compound | 20 + 2000 + 500 | 10 | 10 |
| B + Compound D | | | |
| I-b-16 + Compound | 200 + 1000 + 20 | 10 | 10 |
| B + Compound D | | | |
| I-b-19 + Compound | 100 + 1000 + 200 | 10 | 10 |
| B + Compound D | | | |
| I-b-20 + Compound | 20 + 100 + 2000 | 9 | 10 |
| B + Compound D | | | |
| I-b-23 + Compound | 100 + 500 + 10 | 10 | 10 |
| B + Compound D | | | |

TABLE 9

| Herbicidal | | | |
|---|---|---|---|
| composition of | | Post-emergence effect | |
| the present | | Echinochloa | |
| invention | Dosage (g/ha) | crus-galli | Setaria faberi |
| I-a-14 + Compound | 10 + 1000 + 500 | 9 | 10 |
| B + Compound E | | | |
| I-a-15 + Compound | 100 + 500 + 10 | 9 | 9 |
| B + Compound E | | | |
| I-a-16 + Compound | 50 + 1000 + 500 | 10 | 10 |
| B + Compound E | | | |
| I-a-17 + Compound | 20 + 100 + 1000 | 10 | 10 |
| B + Compound E | | | |
| I-a-18 + Compound | 20 + 500 + 2000 | 10 | 10 |
| B + Compound E | | | |
| I-b-19 + Compound | 100 + 200 + 1000 | 9 | 9 |
| B + Compound E | | | |
| I-b-20 + Compound | 20 + 2000 + 100 | 10 | 10 |
| B + Compound E | | | |
| I-b-23 + Compound | 100 + 10 + 500 | 10 | 10 |
| B + Compound E | | | |

TABLE 10

| Herbicidal | | | | | |
|---|---|---|---|---|---|
| composition | | | | | |
| of the | | Post-emergence effect | | | |
| present | | Echinochloa | Setaria | Abutilon | Stellaria |
| invention | Dosage (g/ha) | crus-galli | faberi | theophrasti | media |
| I-a-14 + | 20 + 1000 + 100 | 10 | 10 | 10 | 10 |
| Compound B + | | | | | |
| Compound F | | | | | |
| I-a-15 + | 200 + 200 + 400 | 9 | 10 | 9 | 10 |
| Compound B + | | | | | |
| Compound F | | | | | |
| I-a-16 + | 100 + 500 + 200 | 10 | 10 | 10 | 10 |
| Compound B + | | | | | |
| Compound F | | | | | |
| I-a-17 + | 200 + 1000 + 200 | 10 | 10 | 10 | 10 |
| Compound B + | | | | | |
| Compound F | | | | | |
| I-a-18 + | 20 + 100 + 1000 | 9 | 10 | 10 | 10 |
| Compound B + | | | | | |
| Compound F | | | | | |
| I-b-16 + | 50 + 1000 + 200 | 10 | 10 | 10 | 9 |
| Compound B + | | | | | |
| Compound F | | | | | |
| I-b-18 + | 100 + 100 + 400 | 10 | 10 | 10 | 10 |
| Compound B + | | | | | |
| Compound F | | | | | |
| I-b-19 + | 200 + 2000 + 20 | 10 | 10 | 10 | 10 |
| Compound B + | | | | | |
| Compound F | | | | | |
| I-b-20 + | 20 + 2000 + 100 | 10 | 9 | 10 | 10 |
| Compound B + | | | | | |
| Compound F | | | | | |
| I-b-23 + | 200 + 1000 + 20 | 10 | 10 | 10 | 10 |
| Compound B + | | | | | |
| Compound F | | | | | |

TABLE 11

| Herbicidal | | | | | |
|---|---|---|---|---|---|
| composition | | | | | |
| of the | | Post-emergence effect | | | |
| present | | Echinochloa | Setaria | Abutilon | Stellaria |
| invention | Dosage (g/ha) | crus-galli | faberi | theophrasti | media |
| I-a-14 + | 200 + 100 + 500 | 10 | 10 | 10 | 10 |
| Compound B + | | | | | |
| Compound G | | | | | |
| I-a-15 + | 200 + 500 + 100 | 10 | 10 | 10 | 10 |
| Compound B + | | | | | |
| Compound G | | | | | |
| I-a-16 + | 100 + 500 + 1000 | 10 | 10 | 10 | 10 |
| Compound B + | | | | | |
| Compound G | | | | | |
| I-a-17 + | 200 + 1000 + 1000 | 10 | 10 | 10 | 10 |
| Compound B + | | | | | |
| Compound G | | | | | |
| I-a-18 + | 10 + 1000 + 500 | 10 | 10 | 10 | 10 |
| Compound B + | | | | | |
| Compound G | | | | | |
| I-b-16 + | 50 + 100 + 2000 | 10 | 10 | 10 | 10 |
| Compound B + | | | | | |
| Compound G | | | | | |
| I-b-18 + | 10 + 500 + 1000 | 10 | 10 | 10 | 10 |
| Compound B + | | | | | |
| Compound G | | | | | |
| I-b-19 + | 200 + 1000 + 100 | 10 | 10 | 10 | 10 |
| Compound B + | | | | | |
| Compound G | | | | | |
| I-b-20 + | 50 + 2000 + 200 | 10 | 10 | 10 | 10 |
| Compound B + | | | | | |
| Compound G | | | | | |
| I-b-23 + | 200 + 2000 + 100 | 10 | 10 | 10 | 10 |
| Compound B + | | | | | |
| Compound G | | | | | |

### Test Example 2

### Pre-Emergence Treatment Test

Field soil was filled in a plastic cup (8 cm in diameter and 6.5 cm in depth), 2 kinds of weed seeds, Echinochloa crus-galli and Setaria faberi, were sown thereon, and the seeds were covered with soil about 0.5 cm of thickness. A diluent of the formulation containing the compound I-a-14, glyphosate potassium salt and S-metolachlor, or a diluent of the formulation containing the compound I-a-14, glyphosate potassium salt and acetochlor was sprayed over the soil uniformly in a predetermined treatment amount. The compound I-a-14 was prepared by dissolving a predetermined amount of bulk in a dimethylformamide solution of Tween 20 (polyoxyethylene sorbitan fatty acid ester; manufactured by MP Biomedicals Ink Corp., 2%), followed by diluting it with deionized water. Glyphosate potassium salt was prepared by diluting Roundup Original Max (registered trademark) (manufactured by Monsanto) with deionized water. Similarly, S-metolachlor was prepared by diluting Dual II Magnum (registered trademark) (manufactured by Syngenta Crop Protection), and acetochlor was prepared by diluting Harness (registered trademark) (manufactured by Monsanto) with deionized water, respectively. The plants was cultured in the greenhouse after treated with the formulation. 21 days after the treatment, the herbicidal effect was evaluated according to the criteria shown in Table 6.

The pre-emergence treatment test was carried out for the other herbicidal compositions of the present invention according to the same manner except for using the compound I-a-15, I-a-16, I-a-17, I-a-18, I-b-16, I-b-19, I-b-20 or I-b-23 instead of the compound I-a-14. The results are shown in Table 12 to 13.

TABLE 12

| Herbicidal | | | |
|---|---|---|---|
| composition of | | Pre-emergence effect | |
| the present | | Echinochloa | |
| invention | Dosage (g/ha) | crus-galli | Setaria faberi |
| I-a-14 + Compound | 50 + 1000 + 500 | 10 | 10 |
| B + Compound C | | | |
| I-a-15 + Compound | 200 + 100 + 20 | 9 | 10 |
| B + Compound C | | | |
| I-a-16 + Compound | 100 + 10 + 500 | 10 | 10 |
| B + Compound C | | | |
| I-a-17 + Compound | 10 + 1000 + 500 | 10 | 10 |
| B + Compound C | | | |
| I-a-18 + Compound | 10 + 500 + 1000 | 10 | 10 |
| B + Compound C | | | |
| I-b-16 + Compound | 50 + 100 + 1000 | 10 | 9 |
| B + Compound C | | | |
| I-b-19 + Compound | 200 + 500 + 500 | 10 | 10 |
| B + Compound C | | | |
| I-b-20 + Compound | 200 + 20 + 500 | 10 | 10 |
| B + Compound C | | | |
| I-b-23 + Compound | 10 + 100 + 1000 | 10 | 10 |
| B + Compound C | | | |

TABLE 13

| Herbicidal | | | |
|---|---|---|---|
| composition of | | Pre-emergence effect | |
| the present | | Echinochloa | |
| invention | Dosage (g/ha) | crus-galli | Setaria faberi |
| I-a-14 + Compound | 10 + 500 + 1000 | 10 | 10 |
| B + Compound D | | | |
| I-a-15 + Compound | 100 + 10 + 500 | 10 | 10 |
| B + Compound D | | | |
| I-a-16 + Compound | 50 + 500 + 1000 | 10 | 10 |
| B + Compound D | | | |
| I-a-17 + Compound | 20 + 1000 + 100 | 10 | 9 |
| B + Compound D | | | |
| I-a-18 + Compound | 20 + 2000 + 500 | 10 | 9 |
| B + Compound D | | | |
| I-b-16 + Compound | 200 + 1000 + 20 | 10 | 10 |
| B + Compound D | | | |
| I-b-19 + Compound | 100 + 1000 + 200 | 10 | 9 |
| B + Compound D | | | |
| I-b-20 + Compound | 20 + 100 + 2000 | 10 | 10 |
| B + Compound D | | | |
| I-b-23 + Compound | 100 + 500 + 10 | 10 | 10 |
| B + Compound D | | | |

### INDUSTRIAL APPLICABILITY

According to the present invention, it is possible to control weeds by applying an effective amount of the herbicidal composition of the present invention to weeds or soil on which the weeds grow.

1. A herbicidal composition comprising a pyridazinone compound represented by the formula (I): 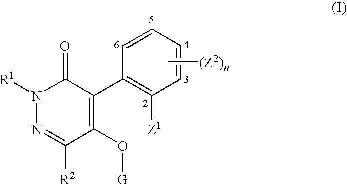
wherein R¹ represents a C₁₋₆ alkyl group or a (C₁₋₆ alkyloxy) C₁₋₆ alkyl group,
R² represents a hydrogen atom or a C₁₋₆ alkyl group,
G represents a hydrogen atom or any one of the groups represented by the following formulas: 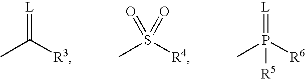
wherein L represents an oxygen atom or a sulfur atom,
R³ represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl) C₁₋₆ alkyl group, a C₁₋₆ alkyloxy group, a C₃₋₈ cycloalkyloxy group, a C₂₋₆ alkenyloxy group, a C₂₋₆ alkynyloxy group, a C₆₋₁₀ aryloxy group, a (C₆₋₁₀ aryl) C₁₋₆ alkyloxy group, an amino group, a C₁₋₆ alkylamino group, a C₂₋₆ alkenylamino group, a C₆₋₁₀ arylamino group, a di(C₁₋₆ alkyl)amino group, a di(C₂₋₆ alkenyl)amino group, a (C₁₋₆ alkyl) (C₆₋₁₀ aryl)amino group or a 3 to 8-membered nitrogen-containing heterocyclic group,
R⁴ represents a C₁₋₆ alkyl group, a C₆₋₁₀ aryl group, a C₁₋₆ alkylamino group or a di(C₁₋₆ alkyl)amino group, and
R⁵ and R⁶ are the same or different and each represents a C₁₋₆ alkyl group, a C₃₋₈ cycloalkyl group, a C₂₋₆ alkenyl group, a C₆₋₁₀ aryl group, a C₁₋₈ alkyloxy group, a C₃₋₈ cycloalkyloxy group, a C₆₋₁₀ aryloxy group, a (C₆₋₁₀ aryl) C₁₋₆ alkyloxy group, a C₁₋₆ alkylthio group, a C₁₋₆ alkylamino group or a di(C₁₋₆ alkylamino group,
provided that any group represented by R³, R⁴, R⁵ and R⁶ may be substituted with at least one halogen atom, and the C₃₋₈ cycloalkyl group, the C₆₋₁₀ aryl group, the aryl moiety of the (C₆₋₁₀ aryl) C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group, the aryl moiety of the C₆₋₁₀ arylamino group, the aryl moiety of the (C₁₋₆ alkyl)(C₆₋₁₀ aryl)amino group and the 3- to 8-membered nitrogen-containing heterocyclic group may be substituted with at least one C₁₋₆ alkyl group,
Z¹ represents a C₁₋₆ alkyl group; Z² represents a C₁₋₆ alkyl group,
n represents 0, 1, 2, 3 or 4, and when n represents an integer of two or more, each Z² may be the same or different, provided that the total number of carbon atoms in the groups represented by Z¹ and n×Z² is two or more;
glyphosate or an agriculturally acceptable salt thereof;
and an herbicidal compound selected from the following group A.
Group A:
metolachloror an optically active isomer thereof,
acetochlor,
atrazine,
dicamba, and
2,4-D or an agriculturally acceptable salt or ester thereof.

2. The herbicidal composition according to claim 1, wherein n in the formula (I) is an integer of 1 or more.

3. The herbicidal composition according to claim 1, wherein n in the formula (I) is 0, and Z¹ is a C₂₋₆ alkyl group.

4. The herbicidal composition according to claim 1, wherein n in the formula (I) is 1 or 2, and Z² is attached to the benzene ring at 4- and/or 6-positions thereof.

5. The herbicidal composition according to claim 1, 2 or 4, wherein Z¹ in the formula (I) is a C₁₋₃ alkyl group, and Z² is a C₁₋₃ alkyl group.

6. The herbicidal composition according to claim 1, wherein G in the formula (I) is a hydrogen atom or any one of the groups represented by the following formulas: 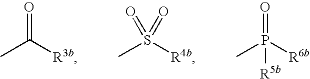
wherein R^{3b} represents a C₁₋₆ alkyl group, a C₃₋₈ cycloalkyl group, a C₂₋₆ alkenyl group, a C₂₋₆ alkynyl group, a C₈₋₁₀ aryl group, a (C₆₋₁₀ aryl) C₁₋₆ alkyl group, a C₁₋₆ alkyloxy aryloxy group, a (C₆₋₁₀ aryl) C₁₋₈ alkyloxy group, a C₁₋₈ alkylamino group, a C₆₋₁₀ arylamino group or a di(C₁₋₆ alkyl)amino group,
R^{4b} represents a C₁₋₆ alkyl group or a C₆₋₁₀ aryl group, and
R^{5b} and R^{6b} are the same or different and each represents a C₁₋₆ alkyl group, a C₁₋₆ alkyloxy group, a C₆₋₁₀ aryloxy group or a C₁₋₈ alkylthio group,
provided that any group represented by R^{3b}, R^{4b}, R^{5b} and R^{6b} may be substituted with at least one halogen atom, and the C₃₋₈ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group and the aryl moiety of the C₆₋₁₀ arylamino group may be substituted with at least one C₁₋₈ alkyl group.

7. The herbicidal composition according to claim 1, wherein G in the formula (I) is a hydrogen atom or any one of the groups represented by the following formulas: 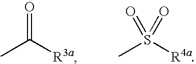
wherein R^{3a} represents a C₁₋₆ alkyl group, a C₃₋₈ cycloalkyl group, a C₆₋₁₀ aryl group, a C₁₋₆ alkyloxy group or a di(C₁₋₆ alkyl)amino group; and
R^{4a} represents a C₁₋₆ alkyl group,
provided that any group represented by R^{3a} and R^{4a} may be substituted with a halogen atom, and a C₃₋₈ cycloalkyl group and a C₆₋₁₀ aryl group may be substituted with a C₁₋₆ alkyl group.

8. The herbicidal composition according to claim 1, wherein R² in the formula (I) is a hydrogen atom or a C₁₋₃ alkyl group.

9. The herbicidal composition according to claim 1, wherein R² in the formula (I) is a hydrogen atom or a methyl group.

10. The herbicidal composition according claim 1, wherein R¹ in the formula (I) is a C₁₋₃ alkyl group or a (C₁₋₃ alkyloxy) C₁₋₃ alkyl group.

11. A weed control method, which comprises simultaneously or separately applying an effective amount of the pyridazinone compound represented by the formula (I) according to claim 1, glyphosate or an agriculturally acceptable salt thereof, and an herbicidal compound selected from the following group A.
Group A:
metolachloror an optically active isomer thereof,
acetochlor,
atrazine,
dicamba, and
2,4-D or an agriculturally acceptable salt or ester thereof.

12. Use of the pyridazinone compound represented by the formula (I) according to claim 1, glyphosate or an agriculturally acceptable salt thereof', and a herbicidal compound selected from the following group A, for weed control.
Group A:
metolachloror an optically active isomer thereof,
acetochlor,
atrazine,
dicamba, and
2,4-D or an agriculturally acceptable salt or ester thereof.
